(19) United States
(12) Patent Application Publication
(10) Pub. No.: US 2011/0216159 A1
(43) Pub. Date: Sep. 8, 2011

(54) IMAGING CONTROL DEVICE AND IMAGING CONTROL METHOD

(75) Inventor: Shingo Yoshizumi, Tokyo (JP)

(73) Assignee: Sony Corporation, Tokyo (JP)

(21) Appl. No.: 13/037,638

(22) Filed: Mar. 1, 2011

(30) Foreign Application Priority Data
Mar. 8, 2010 (JP) 2010-050086

(51) Int. Cl. H04N 5/225

(52) U.S. Cl. 348/36; 348/E05.024

(57) ABSTRACT

An imaging control device for an imaging apparatus or an imaging system that includes an imaging unit imaging a subject and a variable mechanism of an imaging viewing field of the imaging unit, includes: a variable imaging viewing field control unit that controls driving of the variable mechanism of the imaging viewing field; and an automatic panorama imaging control unit that, while changing the imaging viewing field by using the variable imaging viewing field control unit, allows the imaging unit to acquire a plurality of image data used for generating panorama image data through imaging as panorama imaging and determines a control operation at the time of the panorama imaging based on an captured image signal acquired by the imaging unit.

### BACKGROUND OF THE INVENTION

1. Field of the Invention

The present invention relates to an imaging control device and an imaging control method for an imaging apparatus and an imaging system that perform still-image imaging or panorama imaging by automatically changing the imaging viewing field.

2. Description of the Related Art

Technologies for acquiring a still image of a wide-angle scene by performing an imaging operation while a user (cameraman) moves a camera in an approximately horizontal rotary direction is known as a so-called panorama imaging process. For example, in JP-A-11-88754, JP-A-11-88811, and JP-A-2005-333396, technologies relating to the panorama imaging process are disclosed.

In a case where imaging is performed using a digital still camera in a panorama imaging mode, a user moves the camera in the horizontal rotary direction. At this time, the digital still camera generates panorama image data as a horizontally-long still image by acquiring data of a plurality of still images and performing a composition process by combining subject scenes.

Through such a panorama imaging process, a wide-angle scene can be acquired as one still image, which is difficult to be acquired in an ordinary imaging operation.

In addition, systems that perform an automatic imaging operation not through a user's release operation are known. For example, in JP-A-2009-100300, a technology for automatically recording a captured image that is acquired by automatic composition adjustment and composition combining of an imaging system that includes a digital still camera and a pan head that changes the direction of pan/tilt of the digital still camera through electrical driving is disclosed.

In the technology disclosed in JP-A-2009-100300, a search for a subject as a person is performed, for example, by using a face detecting technology. More specifically, detection of a subject (a face of a person) transferred within an image frame is performed while rotating the digital still camera in the pan direction using the pan head.

As a result of the subject search, in a case where a subject is detected within the image frame, determination of a composition that is optimal in accordance with the detected status (for example, the number, the position, the size, or the like of subjects) of the subject within the image frame at that time point is performed (optimal composition determining). In other words, optimal angles of the pan, tilt, and zoom are acquired.

In addition, when the angles of the pan, tilt, and zoom that are determined to be optimal are acquired through the optimal composition determining, the angles of the pan, tilt, and zoom are adjusted to the acquired angles set as target angles (composition combining).

After completion of the composition combining, the captured image is automatically recorded.

According to the automatic imaging operation (automatic recording of captured images) through automatic composition combining, a captured image according to an optimal composition can be automatically recorded without demanding user's imaging operation.

### SUMMARY OF THE INVENTION

Here, in the above-described automatic imaging operation, in a case where a panorama imaging operation can be performed in addition to an ordinary still-image imaging operation, the use range of the imaging device can be broadened, which is preferable.

It is therefore desirable to provide technology capable of appropriately performing an automatic panorama imaging operation. For example, the range and the composition of the panorama imaging operation are desired to be appropriately controlled.

According to an embodiment of the present invention, there is provided an imaging control device for an imaging apparatus or an imaging system that includes an imaging unit imaging a subject and a variable mechanism of an imaging viewing field of the imaging unit. The imaging control device includes: a variable imaging viewing field control unit that controls driving of the variable mechanism of the imaging viewing field; and an automatic panorama imaging control unit that, while changing the imaging viewing field by using the variable imaging viewing field control unit, allows the imaging unit to acquire a plurality of image data used for generating panorama image data through imaging as panorama imaging and determines a control operation at the time of the panorama imaging based on an captured image signal acquired by the imaging unit.

In the above-described imaging control device, the automatic panorama imaging control unit may determine a start position and an end position of the panorama imaging based on determination of existence of a predetermined target subject that is recognized based on the captured image signal acquired by the imaging unit.

For example, the automatic panorama imaging control unit sets as a start position of the panorama imaging a position of the imaging viewing field at a time when the target subject is determined not to exist for a predetermined range or for predetermined time based on the captured image signal that is acquired by the imaging unit when allowing the variable imaging viewing field control unit to move the imaging viewing field using the variable mechanism, and the automatic panorama imaging control unit sets as an end position of the panorama imaging a position of the imaging viewing field at a time when the target subject is determined not to exist for the predetermined range or the predetermined time based on the captured image signal that is acquired by the imaging unit in the middle of performing the panorama imaging.

In addition, in the above-described imaging control device, the automatic panorama imaging control unit may determine a start position and an end position of the panorama imaging based on history information that represents existence of a predetermined target subject and is generated based on the captured image signal acquired by the imaging unit in the past.

For example, the automatic panorama imaging control unit determines a distribution of existence of the target subject that is acquired based on the history information and determines the start position and the end position of the panorama imaging based on the distribution of existence.

In addition, the automatic panorama imaging control unit may perform composition adjustment based on a distribution of existence of the target subject at positions in the horizontal direction and positions in the vertical direction and a size of a panorama image of the target subject that are acquired based on the history information. In this case, the automatic panorama imaging control unit, as the composition adjustment, calculates a zoom magnification rate and allows the variable imaging viewing field control unit to change the zoom magnification rate of a zoom mechanism that is one of the variable mechanisms.

According to another embodiment of the present invention, there is provided an imaging control device for an imaging apparatus or an imaging system that includes an imaging unit imaging a subject and a variable mechanism of an imaging viewing field of the imaging unit. The imaging control device includes: a variable imaging viewing field control unit that controls driving of the variable mechanism of the imaging viewing field; and an automatic panorama imaging control unit that, while changing the imaging viewing field by using the variable imaging viewing field control unit, allows the imaging unit to acquire a plurality of image data used for generating panorama image data through imaging as panorama imaging and determines a control operation at the time of the panorama imaging in accordance with a trigger for performing the panorama imaging.

In addition, in the above-described imaging control device, the automatic panorama imaging control unit may determine a start position and an end position of the panorama imaging such that a horizontal position of a user operation becomes a center of a panorama image, in a case where the panorama imaging is performed in accordance with the trigger on the basis of the user operation.

In addition, in the above-described imaging control device, the automatic panorama imaging control unit may perform the panorama imaging while changing the imaging viewing field in a 360° range in the horizontal direction by using the variable imaging viewing field control unit, with a current position in the horizontal direction being used as a start position, in a case where the panorama imaging is performed in accordance with the trigger for 360° panorama imaging.

In addition, in the above-described imaging control device, the panorama imaging control unit may perform panorama imaging control in accordance with the trigger that occurs based on the number of existing predetermined target subjects or a separation distance between a plurality of the predetermined target subjects that is recognized based on the captured image signal acquired by the imaging unit.

Alternatively, the above-described imaging control device may further includes: an automatic still-image imaging control unit that allows the imaging apparatus to automatically perform still-image imaging by performing subject detection while changing the imaging viewing field by using the variable imaging viewing field control unit, wherein the panorama imaging control unit performs the panorama imaging control in accordance with the trigger that occurs based on the number of times of the still-image imaging, a period of the automatic still-image imaging, or completion of the automatic still-image imaging in a predetermined range, according to control of the automatic still-image imaging control unit.

In such a case, the automatic panorama imaging control unit may determine a start position and an end position of the panorama imaging based on determination of existence of a predetermined target subject that is recognized based on the captured image signal acquired by the imaging unit.

Alternatively, the automatic panorama imaging control unit may determine a start position and an end position of the panorama imaging based on history information that represents existence of a predetermined target subject and is generated based on the captured image signal acquired by the imaging unit in the past.

In addition, in the above-described imaging control device, the panorama imaging control unit may perform panorama imaging control in accordance with the trigger that occurs based on a subject status that is estimated based on the captured image signal acquired by the imaging unit and/or a surrounding sound.

In addition, in the above-described imaging control device, the panorama imaging control unit may perform panorama imaging control in accordance with a trigger that occurs based on a predetermined type of the subject that is recognized based on the captured image signal acquired by the imaging unit.

In such a case, the automatic panorama imaging control unit, as composition adjustment before start of the panorama imaging, may allow the variable imaging viewing field control unit to only perform control of adjustment of a position of the imaging viewing field in the vertical direction.

According to still another embodiment of the present invention there is provided a method of controlling imaging including the step of allowing the imaging unit to acquire a plurality of image data used for generating panorama image data through imaging as panorama imaging while changing the imaging viewing field by controlling driving of the variable mechanism and determining a control operation at the time of the panorama imaging based on an captured image signal acquired by the imaging unit before or during the performing of the panorama imaging.

According to yet another embodiment of the present invention there is provided a method of controlling imaging, including the step of determining a control operation at the time of panorama imaging in accordance with a trigger for performing the panorama imaging; and allowing the imaging unit to acquire a plurality of image data used for generating panorama image data through imaging as panorama imaging by the determined control operation while changing the imaging viewing field by controlling driving of the variable mechanism.

According to the embodiment of the present invention, first, by determining a control operation at the time of panorama imaging based on a captured image signal acquired by the imaging unit before or during panorama imaging, panorama imaging capable of acquiring a panorama image having an appropriate composition, for example, according to the position of existence, the distribution, the number or the like of specific target subjects (for example, faces of persons) can be realized.

In addition, by determining a control operation at the time of panorama imaging in accordance with a trigger for performing the panorama imaging, panorama imaging capable of acquiring a panorama image having an appropriate composition according to the content of the trigger, the surrounding status, and the like can be realized.

According to the embodiment of the present invention, the range and the composition of automatic panorama imaging are appropriately controlled in accordance with the status that is acquired from a captured image signal or the type of a trigger for performing panorama imaging. Therefore, appropriate automatic panorama imaging according to various statuses is realized.

### BRIEF DESCRIPTION OF THE DRAWINGS

FIGS. 1A and 1B are a front view and a rear view of a digital still camera according to an embodiment of the present invention.

FIGS. 2A and 2B are a perspective view and a rear view of a pan head on which a digital still camera according to the embodiment can be mounted.

FIG. 3 is a front view of a state in which a digital still camera according to the embodiment is mounted on a pan head.

FIG. 4 is a schematic diagram illustrating the movement in the pan direction in a state in which a digital still camera according to the embodiment is mounted on a pan head.

FIGS. 5A and 5B are schematic diagrams illustrating the movement in the tilt direction in a state in which a digital still camera according to the embodiment is mounted on a pan head.

FIGS. 6A and 6B are schematic diagram illustrating a touch operation position of a pan head according to an embodiment of the present invention.

FIG. 7 is a block diagram showing an example of the internal configuration of a digital still camera according to an embodiment of the present invention.

FIG. 8 is a block diagram showing an example of the internal configuration of a pan head according to an embodiment of the present invention.

FIG. 9 is a schematic diagram illustrating an example of the control function configuration according to an embodiment of the present invention.

FIGS. 10A, 10B, and 10C are a schematic diagrams illustrating panorama imaging according to an embodiment of the present invention.

FIG. 11 is a flowchart of the first example of an automatic imaging process to which an embodiment of the present invention can be applied.

FIG. 12 is a flowchart of the second example of the automatic imaging process to which an embodiment of the present invention can be applied.

FIG. 13 is a flowchart of Process Example I of panorama imaging according to an embodiment of the present invention.

FIG. 14 is a schematic diagram illustrating Process Example I of panorama imaging according to an embodiment of the present invention.

FIGS. 15A and 15B are schematic diagrams illustrating Process Example I of panorama imaging according to an embodiment of the present invention.

FIG. 16 is a flowchart of Process Example II of panorama imaging according to an embodiment of the present invention.

FIGS. 17A, 17B, and 17C are schematic diagrams illustrating Process Example II of panorama imaging according to an embodiment of the present invention.

FIG. 18 is a flowchart of Process Example III of panorama imaging according to an embodiment of the present invention.

FIGS. 19A and 19B are schematic diagrams illustrating imaging history information and face detection map information according to an embodiment of the present invention.

FIGS. 20A and 20B are schematic diagrams illustrating Process Example III of panorama imaging according to an embodiment of the present invention.

FIGS. 21A and 21B are schematic diagrams illustrating Process Example III of panorama imaging according to an embodiment of the present invention.

FIG. 22 is a flowchart of Process Example IV of panorama imaging according to an embodiment of the present invention.

FIG. 23 is a flowchart of zoom control of Process Example IV of panorama imaging according to an embodiment of the present invention.

FIGS. 24A and 24B are schematic diagrams illustrating Process Example IV of panorama imaging according to an embodiment of the present invention.

FIGS. 25A, 25B, and 25C are schematic diagrams illustrating zoom determination of Process Example IV of panorama imaging according to an embodiment of the present invention.

FIG. 26 is a flowchart of Process Example V of panorama imaging according to an embodiment of the present invention.

FIGS. 27A and 27B are flowcharts of the processes of occurrences of triggers according to an embodiment of the present invention.

FIGS. 28A and 28B are flowcharts of the processes of occurrences of triggers according to an embodiment of the present invention.

FIGS. 29A and 29B are flowcharts of the processes of occurrences of triggers according to an embodiment of the present invention.

FIGS. 30A and 30B are flowcharts of the processes of occurrences of triggers according to an embodiment of the present invention.

FIG. 31 is a schematic diagram illustrating an example of a control process according to a trigger, according to an embodiment of the present invention.

FIG. 32 is a schematic diagram illustrating another functional configuration according to an embodiment of the present invention.

### DESCRIPTION OF THE PREFERRED EMBODIMENTS

Hereinafter, embodiments of the present invention will be described in the order as below. In the embodiments, an imaging system that is configured by a digital still camera and a pan head on which the digital still camera can be mounted will be described as an example. Although the digital still camera alone can pick up an image, the digital still camera combined with a pan head as an imaging system can perform an automatic imaging operation.

<1. Configuration of Imaging System>

[1-1: Entire Configuration]

[1-2: Digital Still Camera]

[1-3: Pan Head]

<2. Example of Functional Configuration>

<3. Overview of Panorama Imaging>

<4. Automatic Imaging Process>

[4-1: Example of First Automatic Imaging Process]

[4-2: Example of Second Automatic Imaging Process]

<5. Panorama Imaging Process>

[5-1: Process Example I]

[5-2: Process Example II]

[5-3: Process Example III]

[5-4: Process Example IV]

[5-5: Process Example V]

<6. Trigger to Panorama Imaging>

[6-1: Example of Various Triggers]

[6-2: Process Setting according to Trigger]

<7. Example of Other Functional Configurations>

<8. Program>

In the description here, terms “image frame”, “image angle”, “imaging field of view”, and “composition” are used, and the definitions thereof are as below.

An “image frame” represents a regional range corresponding to one image, for example, into which an image is fitted so as to be viewed. Generally, the outer frame shape of the image frame is a vertically-long or horizontally-long rectangle.

An “image angle” is also termed a zoom angle or the like and represents a range that is fitted within an image frame determined in accordance with the position of a zoom lens of an optical system of an imaging apparatus as an angle. Generally, although the image angle is determined in accordance with a focal distance of the imaging optical system and the size of an image surface (an image sensor or a film), here, a factor that can be changed in correspondence with a focal distance is termed the image angle.

An “imaging field of view” represents a field of view according to the imaging optical system. In other words, the imaging field of view is a range fitted into the image frame in the middle of a surrounding scene of the imaging apparatus as an imaging target. The imaging field of view is determined in accordance with a swing angle in the pan (horizontal) direction and an angle (an elevation angle or a depression angle) in the tilt (vertical) direction in addition to the above-described image angle.

A “composition” here is also termed a framing and, for example, represents a configuration state within the image frame, for example, determined in accordance with the imaging field of view including setting of the size of a subject.

### <1. Configuration of Imaging System>

### [1-1: Entire Configuration]

An imaging system according to an embodiment of the present invention is configured by a digital still camera 1 and a pan head 10 to which the digital still camera 1 is detachably attached.

The pan head 10 changes the orientation of the digital still camera 1 in the pan and tilt directions through electrical driving. In addition, the pan head 10 performs automatic composition matching and automatic recording of a captured image that is acquired through the automatic composition matching.

For example, by using face detecting technology, a search for a subject as a person is performed. More specifically, while rotating the digital still camera 1, for example, in the pan direction by using the pan head 10, a subject (a face of a person) of which the image is output within the image frame is detected.

When a subject is detected within the image frame as a result of the search for a subject, a composition that is regarded to be optimized according to the of the detection status of the subject (for example, the number, the position, the size, and the like of subjects) within the image frame at the time point is determined (optimal composition determining). In other words, the angles of pan, tilt, and zoom that are regarded as optimal are acquired.

When the angles of pan, tilt, and zoom that are regarded as optimal through the optimal composition determining are acquired as described above, the angles of pan, tilt, and zoom are adjusted with such angles set as target angles (composition matching).

After completion of the composition matching, automatic recording of a captured image is performed.

According to an automatic imaging operation (automatic recording of a captured image) through the above-described automatic composition matching, an imaging operation of a user is not necessary at all, and a captured image can be automatically recorded in accordance with a composition that is regarded as optimal.

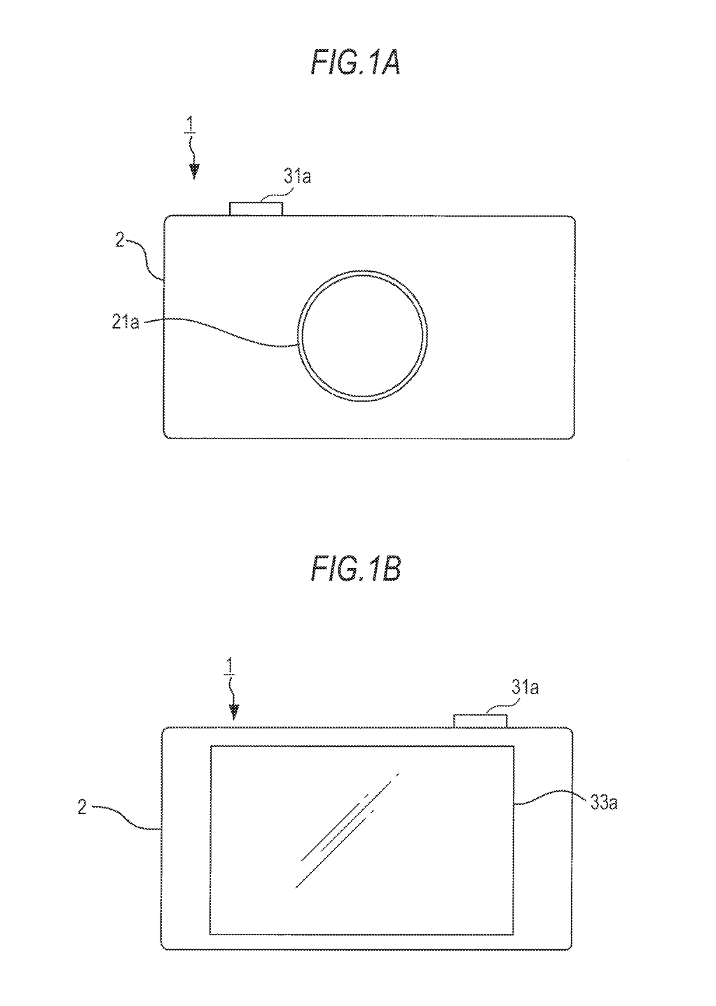

FIGS. 1A and 1B show examples of external views of the digital still camera 1. FIGS. 1A and 1B are a front view and a rear view of the digital still camera 1.

The digital still camera 1, as shown in FIG. 1A, includes a lens unit 21a on the front face side of a main body unit 2. The lens unit 21a is an optical system used for capturing an image and is a portion exposed to the outer side of the main body unit 2.

In addition, in an upper face portion of the main body unit 2, a release button 31a is disposed. In an imaging mode, an image (captured image) captured by the lens unit 21a is generated as an image signal. In the imaging mode, captured image data for each frame can be acquired at a predetermined frame rate by an image sensor to be described later.

When the release button 31a is operated (a release operation or a shutter operation), a captured image (frame image) at that timing is recorded on a recording medium as image data of a still image. In other words, imaging of a still image that is generally called photographing is performed.

In addition, the digital still camera 1, as shown in FIG. 1B, includes a display screen unit 33a on the rear face side thereof.

On this display screen unit 33a, in the imaging mode, an image called a through image or the like that is imaged by the lens unit 21a at that time is displayed. The through image is a moving image based on frame images that are acquired by the image sensor and is an image that directly represents a subject at that time.

On the other hand, in a reproduction mode, image data recorded on the recording medium is reproduced so as to be displayed.

In addition, an operation image as a GUI (Graphical User Interface) is displayed in accordance with an operation performed by the user for the digital still camera 1.

In addition, by building a touch panel into the display screen unit 33a, the user can perform a necessary operation by touching the display screen unit 33a with his or her finger.

Furthermore, in the digital still camera 1, operation elements such as various keys other than the release button 31a and a dial may be disposed.

For example, the operation elements are operation keys, a dial, and the like used for a zoom operation, mode selection, a menu operation, a cursor operation on a menu, a reproduction operation, or the like.

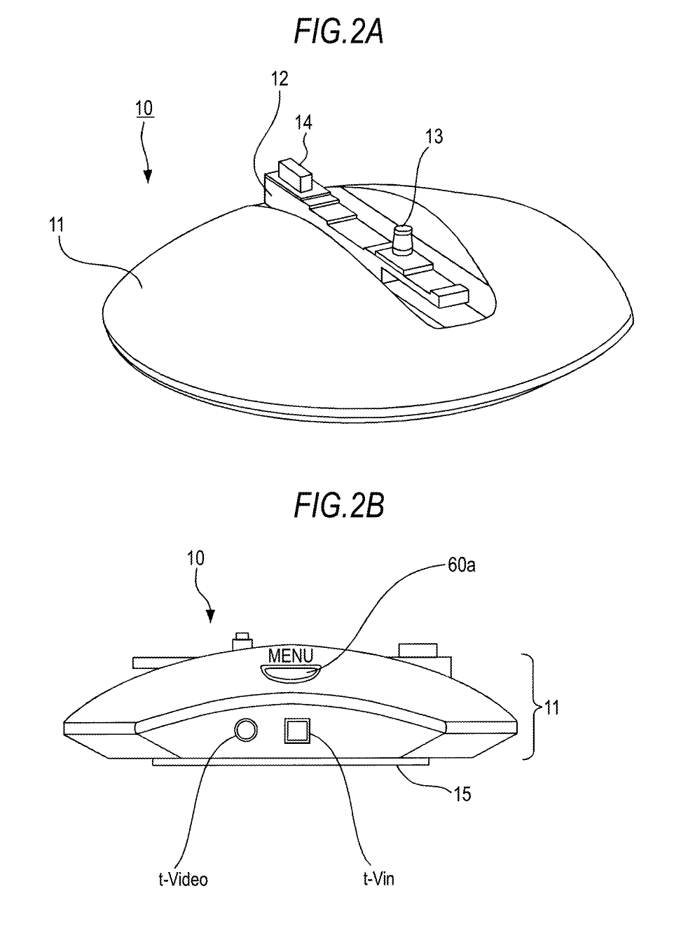

FIG. 2A is a perspective view showing the outer appearance of the pan head 10. FIG. 2B shows a read face view of the pan head 10.

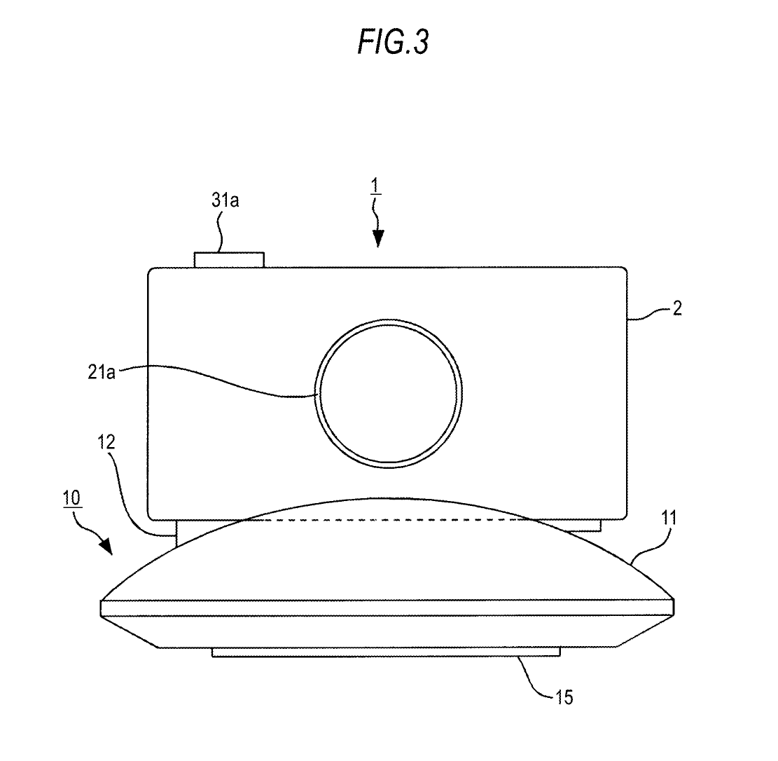

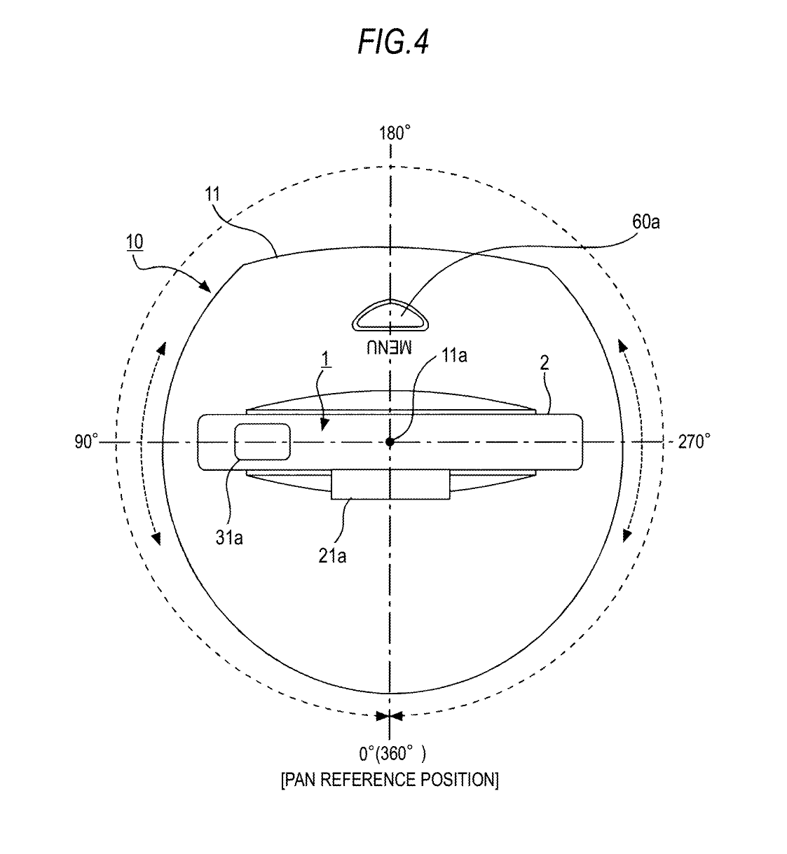

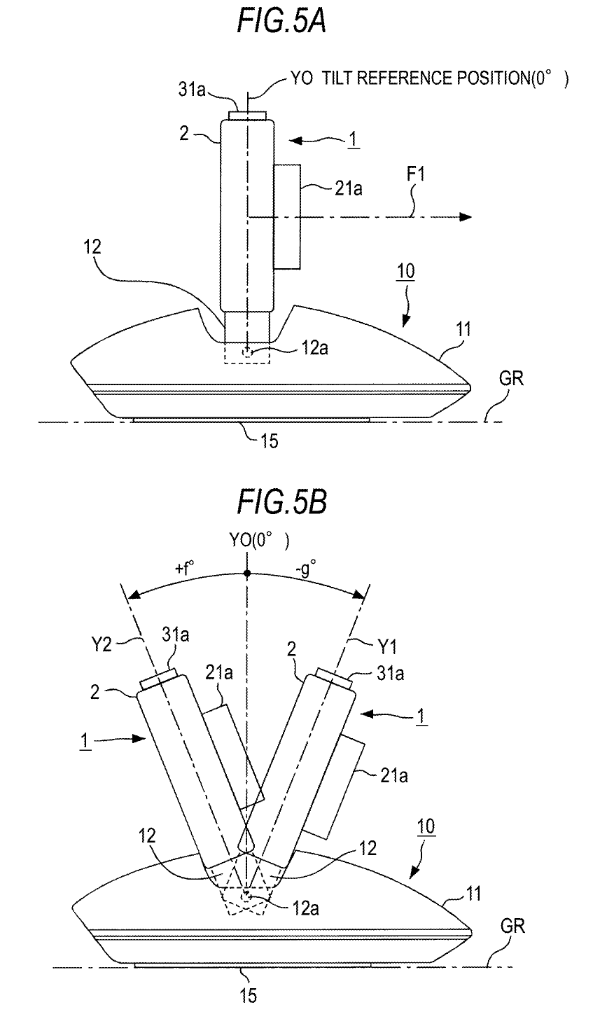

FIGS. 3, 4, 5A, and 5B show states in which the digital still camera 1 is placed in the pan head 10 in an appropriate state. FIG. 3 is a front view, FIG. 4 is a plan view, and FIGS. 5A and 5B are side views (particularly, FIG. 5B shows the movable range of a tilt mechanism in the side view).

As shown in FIGS. 2A, 2B, 3, 4, FIG. 5A, and FIG. 5B, the pan head 10 basically has a structure in which a main body portion 11 is mounted on a ground stand portion 15, and a camera seat portion 12 is installed to the main body portion 11.

When the digital still camera 1 is installed to the pan head 10, the lower face side of the digital still camera 1 is placed to the upper face side of the camera seat portion 12.

As shown in FIGS. 2A and 2B, on the upper face portion of the camera seat portion 12, a protruded portion 13 and a connector 14 are disposed. Although not shown in the figure, on the lower face portion of the main body unit 2 of the digital still camera 1, a hole portion that is engaged with the protruded portion 13 is formed. In a state in which the digital still camera 1 is placed appropriately in the camera seat portion 12, a state is formed in which the hole portion and the protruded portion 13 are engaged with each other. In this state, for an ordinary panning or tilting operation of the pan head 10, it is regarded that the digital still camera 1 is not disconnected or deviated from the pan head 10.

In addition, in a predetermined position of the lower face portion of the digital still camera 1, a connector is disposed. In the state in which the digital still camera 1 is appropriately installed to the camera seat portion 12 as described above, the connector of the digital still camera 1 and the connector 14 of the pan head 10 are connected together and a state is formed in which both parties at least can communicate with each other.

For example, the positions of the connector 14 and the protruded portion 13 in the camera seat portion 12, in a practical sense, can be changed (moved) within a specific range. In addition, for example, by using an adaptor or the like that is adjusted to the shape of the lower face portion of the digital still camera 1 together, a digital still camera of a different model can be installed to the camera seat portion 12 in the state in which the digital still camera and the pan head 10 can communicate with each other.

Next, the basic movement of the digital still camera 1 in the pan and tilt directions according to the pan head 10 will be described.

First the basic movement in the pan direction is as follows.

In a state in which the pan head 10 is placed, for example, on a table, a floor face, or the like, the lower face of the ground stand portion 15 is grounded. In this state, as shown in FIG. 4, the main body portion 11 side is configured to be rotatable around the rotation axis 11a as a rotation center in the clockwise direction or in the counterclockwise direction. Accordingly, the imaging field of view can be changed in the horizontal direction (a leftward or rightward direction) of the digital still camera 1 that is installed to the pan head 10 (so-called panning).

In addition, the pan mechanism of the pan head 10 in such a case has a structure in which the pan mechanism can rotate unlimitedly by over 360° in any of the clockwise direction and the counter clockwise direction.

In the pan mechanism of the pan head 10, a reference position in the pan direction is determined.

Here, as shown in FIG. 4, it is assumed that the pan reference position is 0° (360°), and the rotation position of the main body portion 11 in the pan direction, that is, the pan position (the pan angle) is represented as 0° to 360°.

In addition, the basic movement of the pan head 10 in the tilt direction is as follows.

The movement in the tilt direction, as shown in FIGS. 5A and 5B, can be acquired by swinging the camera seat portion 12 at the angles in both directions of the elevation angle and the depression angle around the rotation axis 12a as a rotation center.

FIG. 5A shows a state in which the camera seating portion 12 is at the tilt reference position Y0 (0°). In this state, the imaging direction F1 that coincides with the imaging optical axis of the lens unit 21a (an optical system unit) and a ground face portion GR to which the ground stand portion 15 is grounded are parallel to each other.

In addition, as shown in FIG. 5B, first, in the direction of the elevation angle, the camera seat portion 12 can be moved within a range of a predetermined maximum rotation angle +f° from the tilt reference position Y0 (0°) with the rotation axis 12a used as a rotation center. In addition, also in the direction of the depression angle, the camera seat portion 12 can be moved within a range of a predetermined maximum rotation angle −g° from the tilt reference position Y0 (0°) with the rotation angle 12a used as a rotation center.

As above, by moving the camera seat portion 12 in the range of the maximum rotation angle +f° to the maximum rotation angle −g° with the tilt reference position Y0 (0°) used as the base point, the imaging field of view in the tilt direction (vertical direction) of the digital still camera 1 that is installed to the pan head 10 (the camera seat portion 12) can be changed. In other words, a tilting operation can be performed.

As shown in FIG. 2B, on the pan head 10, a power terminal portion t-Vin to which a power cable is detachably connected and a video terminal portion t-Video to which a video cable is detachably connected are formed on the rear face portion of the main body portion 11.

The pan head 10 is configured so as to charge the digital still camera 1 by supplying input power through the power terminal portion t-Vin to the digital still camera 1 installed to the above-described camera seat portion 12.

In other words, the pan head 10 serves as a cradle (dock) used for charging the digital still camera 1.

In this example, for example, when a video signal on the basis of a captured image is transmitted from the digital still camera 1 side, the pan head 10 is configured so as to output the video signal to the outside through the video terminal portion t-Video.

In addition, as shown in FIGS. 2B and 4, a menu button 60a is disposed on the rear face portion of the main body portion 11 of the pan head 10. In accordance with an operation of the menu button, a menu is displayed, for example, on the display screen unit 33a located on the digital still camera 1 side through communication between the pan head 10 and the digital still camera 1. Through this menu display, an operation that is necessary for a user can be performed.

However, in an example (Process Example I to be described later) as this example, as one of triggers for performing panorama imaging to be described later, a user's touch operation is used.

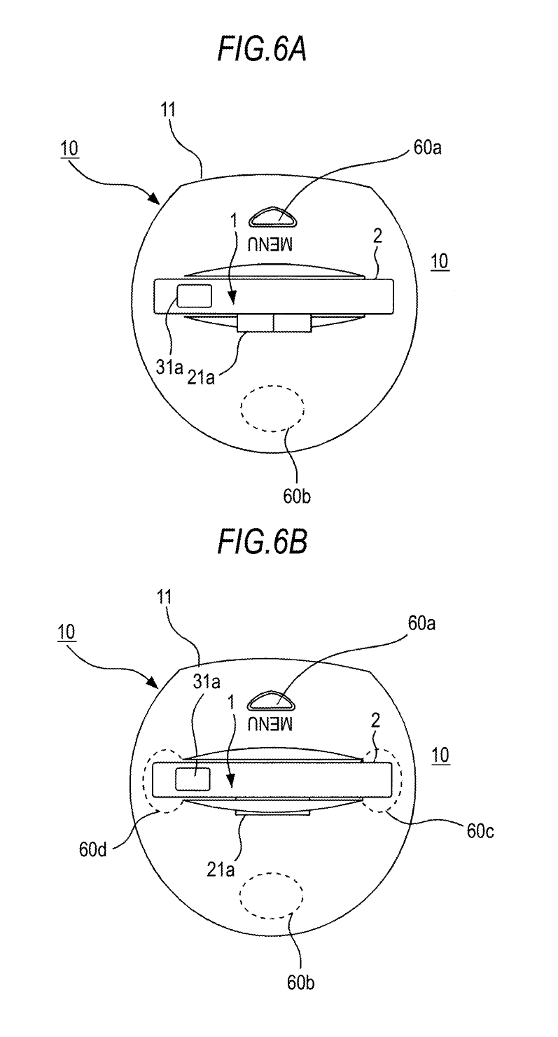

More specifically, the user performs an operation of touching the pan head 10. Accordingly, for example, a touch region 60b is formed on the upper face of the main body portion 11 as shown in FIG. 6A. As the user touches the touch region 60b, a touch sensor installed in the pan head 10 detects the touch operation.

In FIGS. 6A and 6B, a part of the area located on the front face side that is denoted by a broken line is set as the touch region 60b. However, for example, the entirety of the upper face of the main body portion 11 may be set as the touch region 60b.

In FIG. 6B, an example is shown in which, on the upper face of the main body portion 11 of the pan head 10, touch regions 60b, 60c, and 60d are formed on the front side, the right side, and the left side. For example, three touch sensors are installed inside the pan head 10, and touch operations for the touch regions 60b, 60c, and 60d are detected by respective touch sensors.

In such a case, on the side of the imaging system configured by the digital still camera 1 and the pan head 10, a side out of the front side, the right side, and the left side, from which a touch operation is performed by the user, can be determined based on the touch sensor that has detected the touch operation.

Here, an example is shown in which three touch regions 60b to 60d are formed. However, it is apparent that more touch sensors may be included so as to delicately determine the side on which the touch operation is performed in a plurality of touch regions.

Although not shown in the figures, an audio input unit (an audio input unit 62 to be described later) that includes a microphone and an audio input circuit system may be arranged on the pan head 10.

In addition, an imaging unit (an imaging unit 63 to be described later) that includes an imaging lens, an image sensor, an imaging signal processing system, and the like may be arranged on the pan head 10.

These will be sequentially described later.

### [1-2: Digital Still Camera]

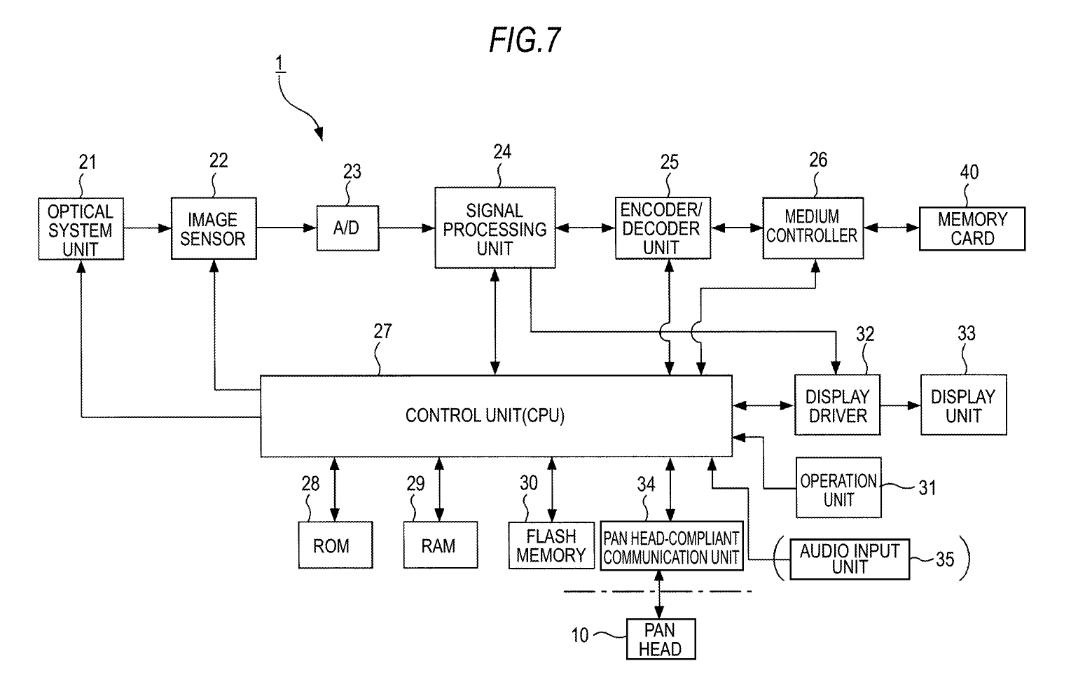

FIG. 7 is a block diagram showing an example of the internal configuration of the digital still camera 1.

An optical system unit 21, for example, is configured by: a group of a predetermined number of imaging lenses including a zoom lens, a focus lens, and the like; a diaphragm; and the like. The optical system unit 21 forms an image on the light reception surface of an image sensor 22 by using incident light as imaging light.

In addition, the optical system unit 21 may further include a driving mechanism unit that is used for driving the zoom lens, the focus lens, the diaphragm, and the like. The operation of the driving mechanism unit is controlled through so-called camera control such as zoom (view angle) control, automatic focus adjustment control, automatic exposure control, and the like that are performed, for example, by the control unit 27.

The image sensor 22 performs so-called photoelectric conversion in which the imaging light acquired by the optical system unit 21 into an electric signal. Accordingly, the image sensor 22 receives the imaging light output from the optical system unit 21 on the light reception surface of a photoelectric conversion device and sequentially outputs signal electric charge that is accumulated in accordance with the intensity of the received light at predetermined timing. Thus, an electric signal (imaging signal) corresponding to the imaging light is output.

The photoelectric conversion device (imaging device) used as the image sensor 22 is not particularly limited. However, in the current situation, for example, a CMOS (Complementary Metal Oxide Semiconductor) sensor, a CCD (Charge Coupled Device), or the like can be used as the image sensor 22. In a case where the CMOS sensor is used, a device (component) corresponding to the image sensor 22 may have a structure in which an analog-digital converter corresponding to an A/D converter 23 to be described later is additionally included.

An imaging signal that is output from the image sensor 22 is input to the A/D converter 23 so as to be converted into a digital signal and is input to a signal processing unit 24.

The signal processing unit 24, for example, is configured by a DSP (Digital Signal Processor). The signal processing unit 24 performs predetermined signal processing according to a program for a digital imaging signal that is output from the A/D converter 23.

The signal processing unit 24 takes in the digital imaging signal, which is output from the A/D converter 23, in units of one still image (frame image). By performing predetermined signal processing for the imaging signal in units of one still image, which has been taken in, the signal processing unit 24 generates captured image data (captured still image data), which is image signal data corresponding to one still image.

In addition, the signal processing unit 24 may perform an image analyzing process, which is used for a subject detecting process or a composition process to be described later, by using the captured image data acquired as above.

In addition, in the case of the panorama imaging mode, the signal processing unit 24 also performs a process in which a plurality of frame images acquired through panorama imaging operation is composed so as to generate panorama image data.

When the captured image data generated by the signal processing unit 24 is recorded in a memory card 40 as a recording medium, the captured image data, for example, corresponding to one still image is output from the signal processing unit 24 to an encoder/decoder unit 25.

The encoder/decoder unit 25 converts the captured image data in units of one still image, which is output from the image processing unit 24, into a format of image data compressed in a predetermined format by performing a compression encoding process using a predetermined still-image image compression encoding method for the captured image data and, for example, adding a header or the like thereto under the control of the control unit 27. Then, the encoder/decoder unit 25 transmits the image data generated as above to a medium controller 26.

The medium controller 26 writes the transmitted image data so as to be recorded in the memory card 40 under the control of the control unit 27. The memory card 40 in such a case is a recording medium, for example, that has an external shape in a card format complying with predetermined standards and a configuration in which a non-volatile semiconductor memory device such as a flash memory is included therein.

The recording medium having the image data recorded thereon may be a form, a type, or the like other than that of the memory card. For example, various recording media such as an optical disc, a hard disk, a semiconductor memory chip such as a flash memory chip that is undetachably installed, and a hologram memory may be used.

In addition, the digital still camera 1 can display a so-called through image that is an image currently being imaged by allowing the display unit 33 to display an image by using the captured image data acquired by the signal processing unit 24.

For example, the signal processing unit 24 takes in the imaging signal output from the A/D converter 23 and generates captured image data corresponding to one still image and continues to perform this operation so as to sequentially generate captured image data corresponding to a frame image of a moving picture. Then the signal processing unit 24 transmits the captured image data sequentially generated as above to the display driver 32 under the control of the control unit 27.

The display driver 32 generates a driving signal used for driving the display unit 33 based on the captured image data that is input from the signal processing unit 24 as described above and outputs the driving signal to the display unit 33. Accordingly, on the display unit 33, images on the basis of the captured image data in units of one still image are sequentially displayed.

When a user sees this, the images being captured at that time are displayed on the display unit 33 as a moving picture. In other words, a through image is displayed.

In addition, the digital still camera 1 can reproduce the image data recorded in the memory card 40 and can display the image on the display unit 33.

Accordingly, the control unit 27 designates image data and directs the medium controller 26 to read data from the memory card 40. In respond to this direction, the medium controller 26 reads data by accessing an address of the memory card 40 in which the designated image data is recorded and transmits the read out data to the encoder/decoder unit 25.

The encoder/decoder unit 25, for example, under the control of the control unit 27, extracts actual data as compressed still image data transmitted from the medium controller 26 and acquires the captured image data corresponding to one still image by performing a decoding process according to the compression encoding for the compressed still image data. Then, the encoder/decoder unit 25 transmits the captured image data to the display driver 32. Accordingly, an image corresponding to the captured image data recorded in the memory card 40 is reproduced and displayed on the display unit 33.

In addition, on the display unit 33, a user interface image (operation image) can be displayed together with the through image, a reproduced image of the image data, and the like.

In such a case, display image data as a user interface image that is necessary for the control unit 27 is generated, for example, in correspondence with the operation state at that time and outputs the display image data to the display driver 32. Accordingly, the user interface image is displayed on the display unit 33.

In addition, this user interface image can be displayed on a display screen of the display unit 33 separately from a monitoring image such as a specific menu screen or a reproduced image of the captured image data. Furthermore, the user interface image can be displayed so as to overlap and composed with a part of the monitoring image or the reproduced image of the captured image data.

The control unit 27 is configured by a CPU (Central Processing Unit) and configures a microcomputer together with a ROM 28, a RAM 29, and the like.

In the ROM 28, for example, in addition to a program to be executed by a CPU as the control unit 27, various types of setting information relating to the operation of the digital still camera 1 and the likes are stored.

The RAM 29 is a main memory device for the CPU.

The flash memory 30 in this case is provided as a non-volatile memory area that is used for storing various types of setting information and the like that are necessarily to be changed (rewritten), for example, in accordance with a user's operation, operation history, or the like.

In addition, in a case where a nonvolatile memory such as a flash memory is used as the ROM 28, instead of the flash memory 30, a part of the memory area of the ROM 28 may be used.

In this embodiment, the control unit 27 performs various processes for automatic imaging.

First, the control unit 27 detects (or allows the signal processing unit 24 to detect) a subject from each frame image acquired by the signal processing unit 24 by changing the field of view and performs a process of searching for a subject located on the surrounding area of the digital still camera 1 as a subject detecting process.

In addition, as a composition process, the control unit 27 performs an optimal composition determining process in which a composition that is optimal for the aspect of the subject detected in accompaniment with detection of a subject is determined based on a predetermined algorithm and composition fitting with the optimal composition acquired by the optimal composition determining process set as a target composition. After such imaging preparation processes are performed, the control unit 27 performs a control process of automatic recording of the captured image.

In addition, the control unit 27 also performs a process for panorama imaging, in other words, directs to image a plurality of frame images as panorama imaging and perform a synthesis process and performs parameter setting in a panorama imaging mode, and the like. Furthermore, the control unit 27 controls the pan head 10 to perform a rotary movement in an approximately horizontal direction for panorama imaging.

Such a control process will be described later.

The operation unit 31 collectively represents various operators included in the digital still camera 1 and an operation information signal output portion that generates an operation information signal corresponding to an operation performed for the operators and outputs the generated operation information signal to the control unit 27.

As the operator, there is the release button 31a shown in FIGS. 1A and 1B. In addition, other various operators (a power button, a mode button, a zoom operation button, an operation dial, and the like) may be provided.

In a case where the display unit 33 is formed as a touch panel, a touch sensor unit thereof is one concrete example of the operation unit 31.

In addition, a reception unit that receives a command signal transmitted from a remote controller is one example of the operation unit 31.

The control unit 27 performs a predetermined process in accordance with the operation information signal that is input from the operation unit 31. Accordingly, an operation of the digital still camera 1 according to an operation of a user is performed.

A pan-head compliant communication unit 34 is a portion that performs communication according to a predetermined communication protocol between the pan head 10 side and the digital still camera 1 side.

For example, in the state in which the digital still camera 1 is mounted on the pan head 10, the pan-head communication unit 34 has a physical layer configuration used for implementing transmission/reception of a communication signal to/from the communication unit of the pan head 10 side and a configuration for realizing a communication process corresponding to a predetermined upper layer of the physical layer. The physical layer configuration includes a connector portion that is connected to the connector 14, in correspondence with FIGS. 2A and 2B.

In addition, in order to enable charging on the pan head 10 side, not only a terminal used for exchanging a communication signal but also a terminal used for transfer of power for charging is disposed in each connector. Although not shown in the figure, a battery installation portion for detachably installing a battery is disposed in the digital still camera 1, and a battery installed to the installation portion is charged based on the power transferred from the pan head 10 side.

In the digital still camera 1, an audio input unit 35 may be disposed. The audio input unit 35 is used for detecting, for example, an input of speech of a specific term or a specific sound (for example, a sound of clapping hands or the like), the volume of surrounding sound, or the like as a trigger input as the start of automatic panorama imaging to be described later. In this embodiment, there is a case where an input audio is used for determining a situation in which surrounding persons are excited.

Furthermore, even in a case where input of speech of a specific term or a specific sound is determined as a determination on the release timing, the audio input unit 35 is provided.

The audio input unit 35 includes a microphone, an audio signal processing circuit including a microphone and a microphone amplifier, an audio analyzing unit determining a specific sound, and the like. The audio analysis may be performed by the control unit 27.

In addition, as the configuration of the digital still camera 1, a configuration example in which a function for recording data in a recording medium such as a memory card 40 is not included may be considered. For example, such a configuration example corresponds to a case where image data is not internally recorded in a recording medium but is output to an external device so as to be displayed or recorded.

In such a case, a configuration example in which a transmission unit transmitting the image data to an external device is included instead of the medium controller 26 may be considered. Such an imaging apparatus is an apparatus that externally outputs image data as an ordinary still image or a panorama image.

### [1-3: Pan Head]

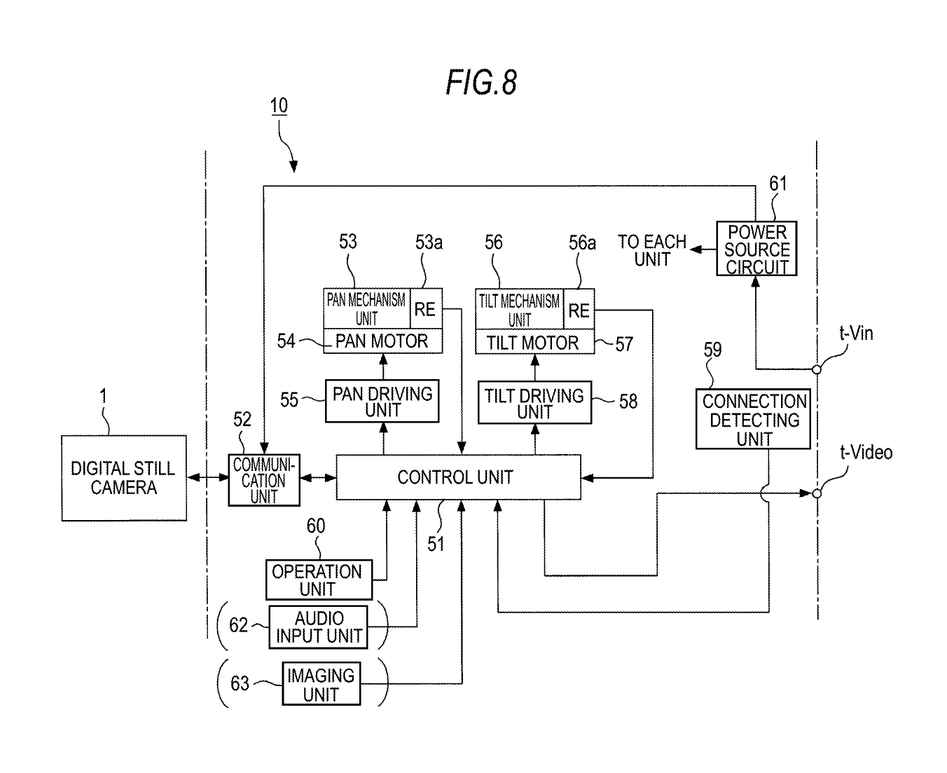

FIG. 8 shows an internal configuration example of the pan head 10.

As shown in FIG. 2B, the power terminal portion t-Vin and the video terminal portion t-Video are disposed in the pan head 10.

The power that is input through the power terminal portion t-Vin is supplied as an operation power of each unit that is necessary inside the pan head 10 through the power source circuit 61. In the power source circuit 61, power for charging of the digital still camera 1 is generated, and the power for charging is supplied to the digital still camera 1 side through a communication unit 52 (connector).

In addition, a video signal transmitted from the digital still camera 1 side is supplied to the video terminal portion t-Video through the communication unit 52 and the control unit 51.

Here, the operation power of each unit of the pan head 10 is represented to be supplied through the power input terminal t-Vin. However, actually, an installation portion of a battery is provided in the pan head 10, and the operation power of each unit can be supplied from a battery installed to the installation portion.

In addition, a connection detecting unit 59 that detects a connection/disconnection of a cable to the power terminal portion t-Vin or the video-terminal portion t-Video is disposed in the pan head 10. As a concrete configuration of a mechanism for detecting a connection/disconnection of a cable, there is a configuration in which a switch is turned on or off, for example, in accordance with connection or pull-out of a cable or the like. As the connection detecting unit 59, a configuration in which a detection signal used for identifying connection/pull-out of a cable is output may be used, and a concrete configuration thereof is not particularly limited.

The detection signals (a detection signal for the power terminal portion t-Vin and a detection signal for the video terminal portion t-Video) of the connection detecting unit 59 are supplied to the control unit 51.

In addition, the pan head 10 includes pan/tilt mechanisms as described above, and as a portion corresponding thereto, a pan mechanism unit 53, a pan motor 54, a tilt mechanism unit 56, and a tilt motor 57 are shown in FIG. 8.

The pan mechanism unit 53 is configured to include a mechanism used for applying a movement for the digital still camera 1 mounted on the pan head 10 in the pan (horizontal or leftward/rightward) direction shown in FIG. 4. The movement of this mechanism can be acquired by rotating the pan motor 54 in the forward or reverse direction.

Similarly, the tilt mechanism unit 56 is configured to include a mechanism used for applying a movement for the digital still camera 1 mounted on the pan head 10 in the tilt (vertical or upward/downward) direction shown in FIGS. 5A and 5B. The movement of this mechanism can be acquired by rotating the tilt motor 57 in the forward or reverse direction.

The control unit 51 is configured by a microcomputer that is formed, for example, by combining a CPU, a ROM, a RAM, and the like and controls the movement of the pan mechanism unit 53 and the tilt mechanism unit 56.

For example, when controlling the movement of the pan mechanism unit 53, the control unit 51 outputs a signal indicating a movement direction and movement speed to the pan driving unit 55. The pan driving unit 55 generates a motor driving signal corresponding to the input signal and outputs the generated motor driving signal to the pan motor 54. For example, in a case where the motor is a stepping motor, the motor driving signal is a pulse signal according to PWM control.

In accordance with this motor driving signal, the pan motor 54 rotates, for example, in a necessary rotation direction at a necessary rotation speed. As a result, the pan mechanism unit 53 is also driven so as to move in the corresponding movement direction at the corresponding speed.

Similarly, when controlling the movement of the tilt mechanism unit 56, the control unit 51 outputs a signal indicating a movement direction and movement speed that are necessary to the tilt mechanism unit 56 to the tilt driving unit 58.

The tilt driving unit 58 generates a motor driving signal corresponding to the input signal and outputs the generated motor driving signal to the tilt motor 57. In accordance with the motor driving signal, the tilt motor 57 rotates in a necessary direction at necessary speed. As a result, the tilt mechanism unit 56 is also driven so as to move in the corresponding movement direction at the corresponding speed.

The pan mechanism unit 53 includes a rotary encoder (a rotation detector) 53a. The rotary encoder 53a outputs a detection signal representing a rotation angle amount corresponding to the rotary movement of the pan mechanism unit 53 to the control unit 51. Similarly, the tilt mechanism unit 56 includes a rotary encoder 56a. The rotary encoder 56a outputs a signal representing a rotation angle amount corresponding to the rotary movement of the tilt mechanism unit 56 to the control unit 51.

Accordingly, the control unit 51 can acquire information on the rotation angle amounts of the pan mechanism unit 53 and the tilt mechanism unit 56 that are in the middle of the operation in real time.

The communication unit 52 is a portion that communicates with the pan-head compliant communication unit 34 located inside the digital still camera 1 mounted on the pan head 10 through a predetermined communication protocol.

This communication unit 52, similarly to the pan-head compliant communication unit 34 has a physical layer configuration used for implementing transmission/reception of a communication signal to/from the communication unit of the opponent side through wire communication or wireless communication and a configuration for realizing a communication process corresponding to a predetermined upper layer of the physical layer. As the physical layer configuration, the connector 14 of the camera seat portion 12 is included in correspondence with in FIG. 2A.

The operation unit 60 collectively represents an operator as the menu button 60a shown in FIGS. 2B and 4 and an operation information signal output portion that generates an operation information signal corresponding to an operation performed for the operator and outputs the operation information signal to the control unit 51. The control unit 51 performs a predetermined process in accordance with the operation information signal input from the operation unit 60.

In addition, in a case where a remote controller is provided for the pan head 10, a reception unit of a command signal transmitted from the remote controller is one example of the operation unit 60.

As described with reference to FIGS. 6A and 6B, a touch sensor may be arranged in the pan head 10. In such a case, the touch sensor is one type of the operation unit 60. A detection signal of the touch sensor for a touch operation is supplied to the control unit 51.

In the pan head 10, an audio input unit 62 may be disposed. The audio input unit 62 is used for detecting, for example, a situation in which the atmosphere is up or an input of speech of a specific term or a specific sound (for example, a sound of clapping hands or the like) as a trigger input as the start of automatic panorama imaging.

The audio input unit 62 includes a microphone, an audio signal processing circuit including a microphone amplifier, an audio analyzing unit determining a specific sound, and the like. The audio analysis may be performed by the control unit 51.

Furthermore, an audio input unit 62 may be disposed on the pan head 10 side in order to respond to a case where an input of the sound of a specific term or a specific sound is determined as a determination on release timing in the digital still camera 1.

In addition, an imaging unit 63 may be disposed in the pan head 10. The imaging unit 63 is disposed so as to detect existence of a specific subject, movement in the surrounding area, or the like as a trigger input as the start of automatic panorama imaging. Alternatively, the imaging unit 63 located on the pan head 10 side may be used, for example, so as to determine the surrounding situation such as an exciting state in the surrounding area through image analysis for controlling the panorama imaging operation. Furthermore, in order to determine the state of a specific subject as a determination on the release timing in the digital still camera 1, the imaging unit 63 may be disposed on the pan head 10 side.

The imaging unit 63 includes an optical system unit, an image sensor, an A/D converter, a signal processing unit, an image analyzing unit, and the like. The image analysis may be performed by the control unit 51.

### <2. Example of Functional Configuration>

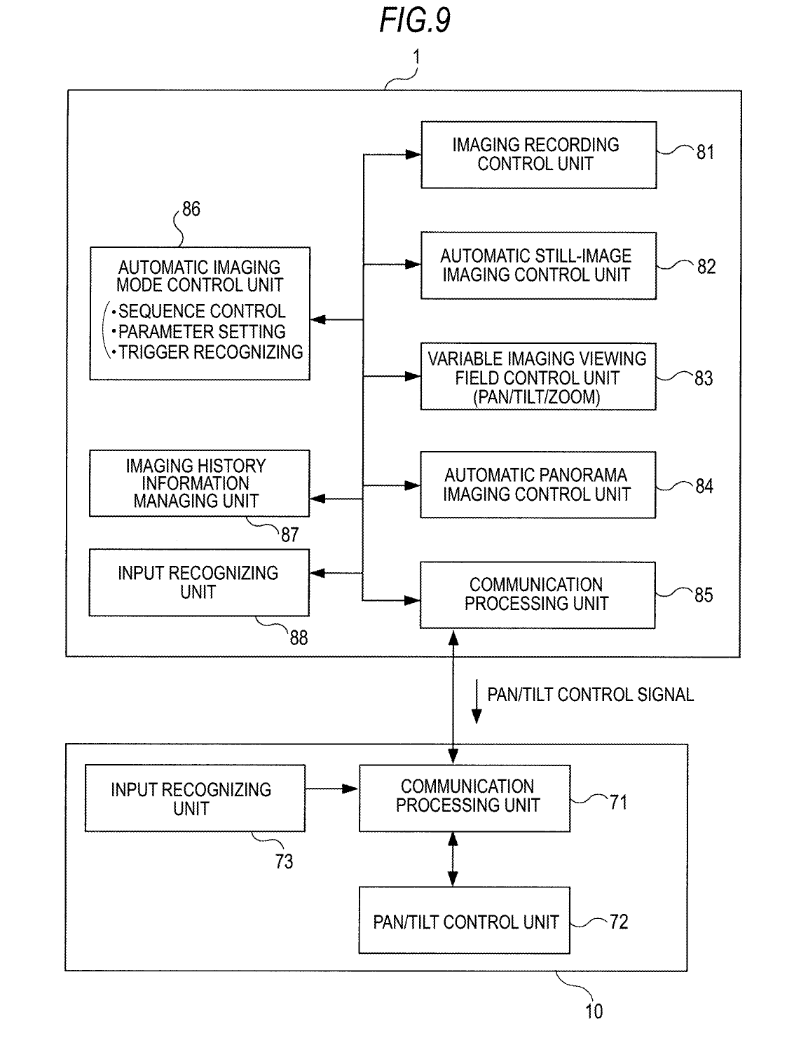

Next, an example of the functional configuration of the digital still camera 1 and the pan head 10 according to this embodiment, which is implemented by hardware and software (program), is shown in a block diagram represented in FIG. 9.

This example of the functional configuration is a configuration for realizing an imaging control device that performs imaging operation control of the imaging system of this example. The example of the functional configuration is mainly a control processing function that is formed by hardware such as the control unit 27 of the digital still camera 1, the control unit 51 of the pan head 10, and the like and a software module that is driven by the hardware are formed so as to be associated with each other.

In FIG. 9, control functions particularly necessary for an automatic panorama imaging process and an automatic still-image imaging process, to be described later, are represented as blocks for each function.

As shown in FIG. 9, the digital still camera 1 (the control unit 27) side includes an imaging and recording control unit 81, an automatic still-image imaging control unit 82, an variable imaging viewing field control unit 83, an automatic panorama imaging control unit 84, a communication processing unit 85, an automatic imaging mode control unit 86, an imaging history information managing unit 87, and an input recognizing unit 88.

The imaging history information managing unit 87 implements a function that is installed particularly in a case where Panorama Imaging Process Examples III and IV, to be described later, are performed.

In addition, the pan head 10 (the control unit 51) side, for example, includes a communication processing unit 71, a pan/tilt control unit 72, and an input recognizing unit 73.

First, on the digital still camera 1 side, the imaging and recording control unit 81 acquires an image acquired by an imaging operation as data (captured image data) of an image signal and performs a control process for storing the captured image data in a recording medium. In addition, the imaging and recording control unit 81 controls reproduction of recorded still image data, a display operation, a through image displaying operation at the time of capturing an image, and the like.

In other words, the imaging and recording control unit 81 controls the optical system unit 21, the image sensor 22, the A/D converter 23, the signal processing unit 24, the encoder/decoder unit 25, the medium controller 26, the display driver 32, and the like shown in FIG. 7. In other words, the imaging and recording control unit 81 is a functional portion that controls the basic operation of the digital still camera 1 including directing a lens driving control of the optical system unit 21, an imaging operation of the image sensor 22, an image signal processing, a recording and reproducing process, and the like and performing still-image imaging and the like.

The automatic still-image imaging control unit 82 is a functional portion that performs various processes that are necessary for performing an automatic still-image imaging process not though a release operation of the user.

As one of the various processes, there is a subject detecting process. This is a process for allowing a subject (for example, a human face) to be fitted into the imaging field of view by checking each frame image acquired by the signal processing unit 24 while performing a pan or tilt operation using the pan head 10. Accordingly, the automatic still-image imaging control unit 82 performs processes such as determination on a necessary pan or tilt operation of the pan head 10, detection of a person through image analysis of the frame image data, and face detection.

In addition, as one of the above-described processes, there is a composition process. A composition process is a process of determining whether the disposition of a subject image in the imaging field of view is in an optimal state (composition determination) and adjusting the composition (composition combination). In order to adjust the composition, the automatic still-image imaging control unit 82 performs the determination on a necessary pan or tilt operation of the pan head 10, determination on driving of the zoom lens of the optical system unit 21, and the like.

In addition, the process functions of the subject detecting process or the image analysis process for the composition process may be performed not by the control unit 27 but by a DSP (Digital signal Processor) as the signal processing unit 24. Accordingly, the functional portion as the automatic still-image imaging control unit 82 may be implemented as a program or an instruction that is supplied to one or both of the control unit 27 and the DSP as the signal processing unit 24.

The variable imaging viewing field control unit 83 is a functional portion that controls an operation of actually changing the imaging field of view. The change in the imaging field of view is made by the pan or tilt operation of the pan head 10 or a zoom operation of the optical system unit 21. Accordingly, the variable imaging viewing field control unit 83 is a functional portion that performs a pan/tilt control and zoom control.

When a camera man manually performs an imaging operation by using the digital still camera 1, the variable imaging viewing field control unit 83, for example, controls the driving of the zoom lens in accordance with the zoom operation of the camera man.

In addition, when automatic still-image imaging or panorama imaging is performed in a state in which the digital still camera 1 is mounted on the pan head 10, the variable imaging viewing field control unit 83 performs zoom driving control, pan driving control, and tilt driving control in accordance with a determination direction of the automatic still-image imaging control unit 82 or a direction transmitted from the automatic panorama imaging control unit 84.

In the pan driving control and the tilt driving control, the variable imaging viewing field control unit 83 transmits a pan/tilt control signal to the pan head 10 side through the communication processing unit 85.

For example, the variable imaging viewing field control unit 83 outputs a pan/tilt control signal used for directing the movement amount to the pan head 10 in accordance with the movement amounts of pan and tilt that are determined by the automatic still-image imaging control unit 82 when performing composition combination or the like.

In addition, the variable imaging viewing field control unit 83 controls the driving of the zoom operation of the optical system unit 21 in accordance with a zoom magnification rate that is determined by the automatic still-image imaging control unit 82.

Furthermore, when panorama imaging is performed in a state in which the digital still camera 1 is mounted on the pan head 10, the variable imaging viewing field control unit 83 transmits a pan/tilt control signal used for mainly directing a pan operation to the pan head 10 side through the communication processing unit 85 for performing rotary movement in the horizontal direction in the panorama imaging.

The automatic panorama imaging control unit 84 is a functional portion that performs various processes that are necessary for performing automatic panorama imaging not through an operation of the user.

As one of the various processes, the automatic panorama imaging control unit 84 controls for performing acquisition of captured images for generating a panorama image while performing panning with a predetermined angle. In other words, the automatic panorama imaging control unit 84 performs panorama imaging control. Accordingly, the automatic panorama imaging control unit 84 directs the variable imaging viewing field control unit 83 so as to allow the pan head 10 to perform necessary panning and directs the imaging and recording control unit 81 for controlling acquisition of captured image data corresponding to a plurality of frames used for generating a panorama image.

In addition, as another process of the above-described processes, there is a subject detecting process. This process is a process for checking existence of a surrounding subject (for example, a human face) or the like by checking each frame image acquired by the signal processing unit 24 while performing a pan/tilt operation using the pan head 10.

Accordingly, the automatic panorama imaging control unit performs processes such as person detection and face detection through image analysis of the frame image data.

In addition, as another process of the above-described processes, there is a composition process for panorama imaging. The composition process in this case is setting an angle range, tilt setting, zoom setting, and the like for performing the panorama imaging process. In order to perform the composition adjustment, the automatic panorama imaging control unit 84 determines a necessary pan/tilt operation of the pan head 10 and driving of the zoom lens of the optical system unit 21 and directs the variable imaging viewing field control unit 83 to perform necessary driving.

In this case, the process functions for the subject detecting process or image analysis performed for the composition process may be performed not by the control unit 27 but by a DSP as the signal processing unit 24. Accordingly, the functional portion as the automatic panorama imaging control unit 84 may be implemented as a program or an instruction that is supplied to one or both of the control unit 27 and the DSP as the signal processing unit 24.

The communication processing unit 85 is a portion that communicates with the communication unit 71 included on the pan head 10 side through a predetermined communication protocol.

The pan/tilt control signal that is generated by the variable imaging viewing field control unit 83 is transmitted to the communication processing unit 71 of the pan head 10 through communication of the communication processing unit 64.

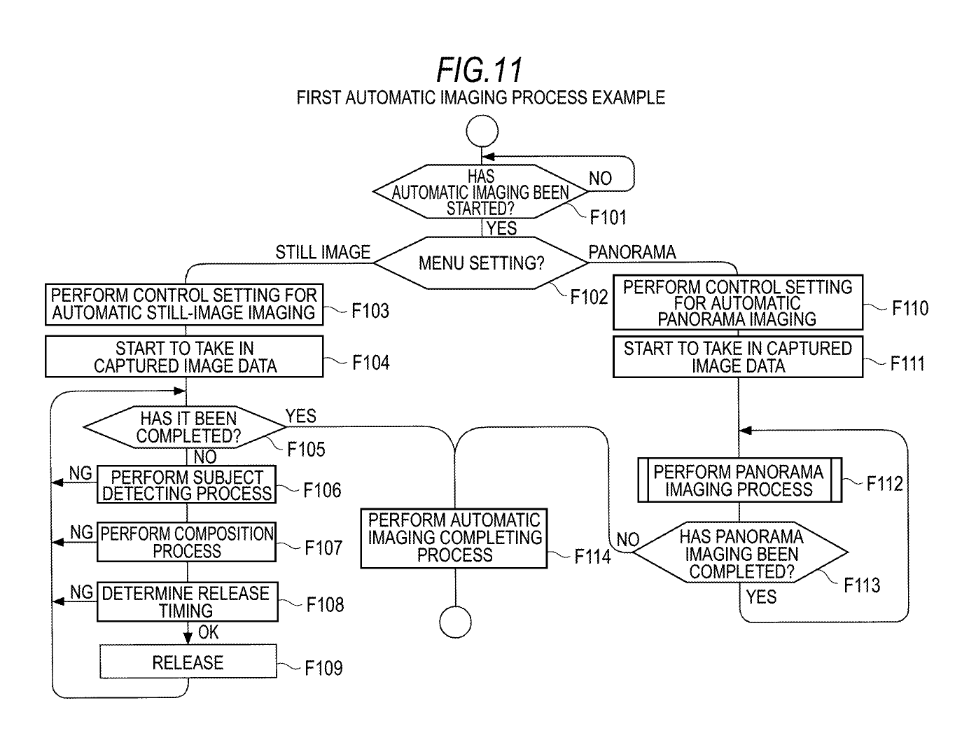

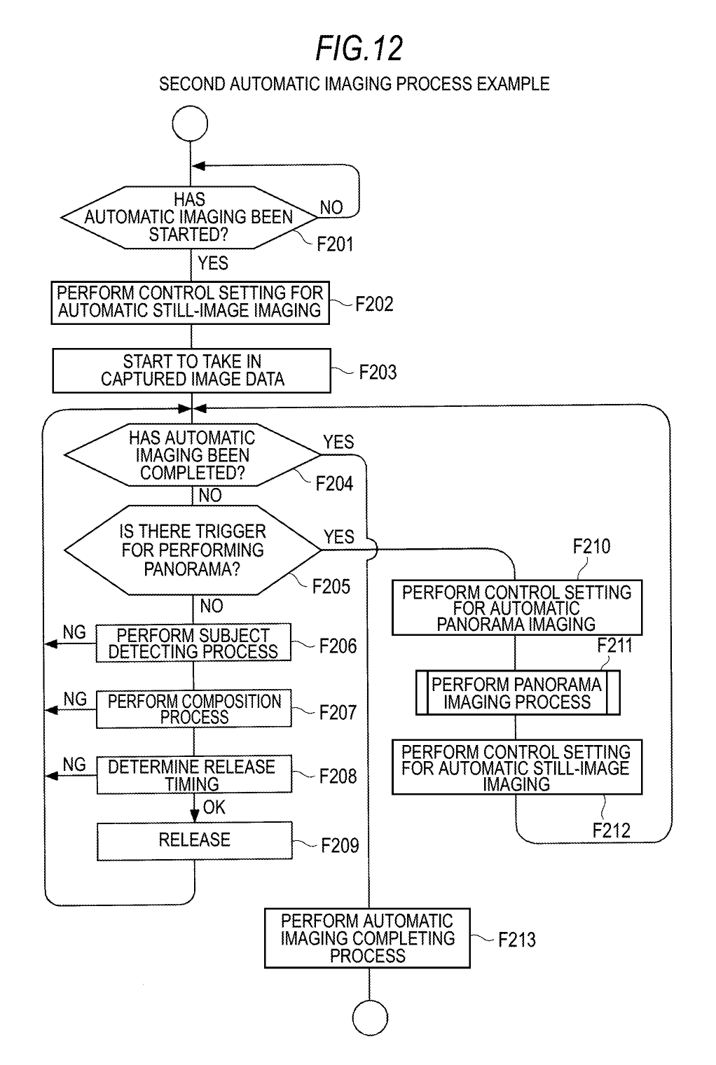

When automatic still-image imaging as an automatic imaging mode performed not through a release operation of the user is performed, the automatic imaging mode control unit 86 performs the operation sequence. More specifically, the automatic imaging mode control unit 86 directs the functional portions to perform the processes as shown in FIGS. 11 and 12 to be described later.

In addition, the automatic imaging mode control unit 86 also performs a recognition process of a trigger input as a determination process in the sequence of the processes shown in FIGS. 11 and 12. For example, the automatic imaging mode control unit 86 performs recognition of a trigger for starting an automatic imaging mode, a trigger for release timing, a trigger for performing panorama imaging, and the like.

For example, when performing imaging and recording of a still image as automatic imaging and the like, the imaging history information managing unit 87 performs a process of storing various types of information at the time of the imaging and recording process or a process of referring to stored imaging history information. The storage of the imaging history information may be performed, for example, by using a memory area of the RAM 29 or the flash memory 30.

In addition, the imaging history information managing unit 87 generates face detecting map information, to be described later, and the like based on the imaging history information.

The input recognizing unit 88 performs a process of recognizing an operation input of the user from the operation unit 31 or an input of an audio from the audio input unit 35.

Next, on the pan head 10 side of the functional configuration shown in FIG. 9, the communication processing unit 71 is a portion that is used for communicating with the communication processing unit 85 located on the digital still camera 1 side.

When receiving the pan/tilt control signal, the communication processing unit 71 outputs the pan/tilt control signal to the pan/tilt control unit 72.

The pan/tilt control unit 72 has a function for performing the process relating to the pan/tilt control, for example, out of control processes performed by the control unit 51 located on the pan head 10 side shown in FIG. 8.

This pan/tilt control unit 72 controls the pan driving unit 55 and the tilt driving unit 58, which are shown in FIG. 8, in accordance with the input pan/tilt control signal. Accordingly, the pan/tilt control unit 72, for example, performs panning/tilting for a panorama imaging process or a subject detecting process or performs panning/tilting for acquiring a horizontal field of view and a vertical field of view that are optimal for the composition process and the like.

The input recognizing unit 73 performs a recognition process of an operation input of a user that is transmitted from the operation unit 60 or an audio input transmitted from the audio input unit 62. Particularly relating to the panorama imaging process, the input recognizing unit 73, for example, performs recognition of a touch sensor input described with reference to FIGS. 6A and 6B. In such a case, the information on the touch sensor input is transmitted to the control unit 27 located on the digital still camera 1 side through the communication processing unit 71.

In FIG. 9, each of the control function portions is represented as a block. However, the control function portions are not necessarily independent program modules or are not necessarily configured by hardware. Actually, as a synthetic process of the control function portions, a process in which the process operation as an embodiment to be described later is implemented may be employed.

### <3. Overview of Panorama Imaging>

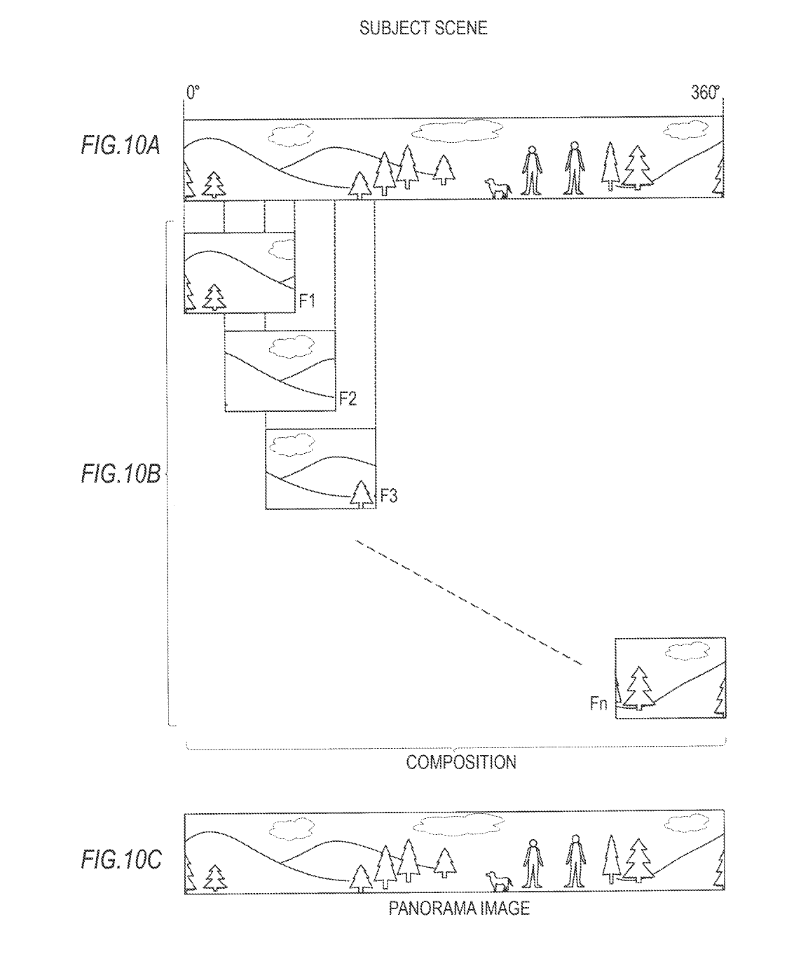

The digital still camera 1 of this embodiment can perform automatic panorama imaging in a state of being mounted on the pan head 10. Here, an overview of the panorama imaging will be described with reference to FIGS. 10A to 10C.

For example, FIG. 10A is a scene of the 360° surrounding of the position of the digital still camera 1 as the center thereof. The panorama imaging is an operation for acquiring such a surrounding scene in a broad range as one image.

The process of the digital still camera 1 is as follows.

For example, in a case where the digital still camera 1 mounted on the pan head 10 automatically performs a panorama imaging process, the digital still camera 1 is rotated by the pan head. In other words, panning is performed. Accordingly, the subject direction (the imaging field of view) of the digital still camera 1 is moved horizontally.

In this process, the digital still camera 1, for example, as shown in FIG. 10B, as denoted by frames F1, F2, F3, . . . , Fn, takes in frame image data that is imaged at each predetermined frame interval.

Then, a synthesis process is performed by using necessary areas of each frame image data F1 to Fn. Here, although a detailed synthesis process will not be described, as a result, a process for combining images captured as a plurality of frame image data is performed. Then, for example, the digital still camera 1 generates panorama image data as shown in FIG. 10C and records the panorama image data in the memory card 40 as panorama image data of one sheet.

For example, when the digital still camera 1 is rotated by 360 degrees by the pan head 10, a scene of the entire surrounding area of the position of the digital still camera 1 as the center thereof is acquired as one panorama image.

Since the digital still camera 1 is rotated by being mounted on the pan head 10, compared to a panorama imaging process in which the subject direction is moved by a user having the digital still camera 1 in his or her hands, a panorama image having high image quality can be acquired. The reason for this is that image synthesis can be appropriately performed owing to vertical evenness in each frame image data and constant panning speed.

### <4. Automatic Imaging Process>

### [4-1: First Example of Automatic Imaging Process]

A first example of the automatic imaging process in the imaging system of this example will be described.

As the automatic imaging mode, two types of the operation including automatic still-image imaging and automatic panorama imaging can be performed. Here, the “automatic still-image imaging” is a term that is differentiated from a panorama image and is an operation of imaging a regular-size still image.

The first example of the automatic imaging process is an example in which one of the still-image imaging and the panorama imaging that is to be performed as an automatic imaging operation is selected and set in advance by a user through a menu operation or the like, and thereafter an operation for starting the automatic imaging operation is performed.

FIG. 11 shows the process of the control unit 27 of the digital still camera 1 that is performed by the mechanism configuration shown in FIG. 9.

When a user directs to perform an automatic imaging operation through a predetermined operation, the control unit 27 (the automatic imaging mode control unit 86) advances the process from Step F101 to Step F102 and checks the user's selected setting.

In a case where the user has selected an automatic imaging operation of an ordinary still image through the menu operation setting, the process proceeds to Step F103. On the other hand, when the user has selected the automatic imaging operation of a panorama image, the process proceeds to Step F110.

First, the case where the automatic still-image imaging operation has been selected will be described.

In Step F103, the control unit 27 (the automatic still-image imaging control unit 82) sets parameters, algorithms, and the like for the automatic still-image imaging operation. For example, the control unit 27 sets a maximum tilt angle, panning speed, the algorithm (condition setting) of the subject detecting composition process, the conditions for release timing, and the like.

After performing various control settings for the automatic still-image imaging operation, the control unit 27 (the automatic still-image imaging control unit 82) actually performs a control process of an automatic still-image imaging operation.

In the automatic still-image imaging operation, the imaging system of this example performs an automatic composition combining operation in which a composition that is determined to be optimal in accordance with the status of the subject detected through a subject detection operation is set as the target composition by performing the subject detection (search) operation, the optimal composition determining operation, and the composition combining operation as preparations of an imaging operation. Then, the imaging system automatically performs a release process under a predetermined condition. Accordingly, an appropriate still-image imaging operation is performed not through any operation of a camera man.

When an imaging operation is started in the automatic still-image imaging mode, captured image data is started to be captured in Step F104.

In other words, the control unit 27 (the imaging and recording control unit 81) starts to capture the captured image data for each frame by using the image sensor 22 and the signal processing unit 24.

Thereafter, until the automatic still-image imaging operation is determined to end in Step F105, the process of Steps F106 to F109 is performed.

In Step F106, a subject detecting process is performed. In Step F107, a composition process is performed.

The subject detecting process and the composition process (the optimal composition determining process and the composition combining process) are performed by the function (more specifically, the process of the control unit 27 and/or the signal processing unit 24) of the automatic still-image imaging control unit 82.

After the captured image data is started to be captured in Step F104, the signal processing unit 24 sequentially acquires frame image data corresponding to one still image as the captured image data capture by the image sensor 22.

The automatic still-image imaging control unit 82 performs a process of detecting an image portion corresponding to a human face from each frame image data as a subject detecting process.

The subject detecting process may be performed for each frame or performed at an interval corresponding to a predetermined number of frames that is set in advance.

In the subject detecting process in this example, for example, by using a so-called face detecting technique, a face range is set in correspondence with a region of a face image portion of a face for each subject detected from the image. Moreover, based on information of the number of face ranges, the size and the position of each face range, and the like, information on the number of subjects within an image frame, the size of each subject, and the position of each subject within the image frame is acquired.

In addition, several face detecting techniques are known.

However, the detection technique to be employed in this embodiment is not particularly limited. Thus, a technique that is appropriate in consideration of the detection precision, design difficulties, and the like may be employed.

As the subject detecting process in Step F106, first, a subject that exists on the surroundings of the digital still camera 1 is searched.

As the search for the subject, the subject detecting process is performed through image analysis of, for example, the signal processing unit 24 (or the control unit 27) while changing the imaging field of view by performing pan/tilt control of the pan head 10 or zoom control of the optical system unit 21 by using the control unit 27 (the automatic still-image imaging control unit 82 and the variable imaging viewing field control unit 83) of the digital still camera 1.

Such a subject search is performed until a subject is detected from a frame image as the captured image data. Then, the subject search is completed by acquiring the state in which a subject (a human face) is located within the frame image, that is, the imaging field of view at that time point.

After the subject detecting process is completed, the control unit 27 (the automatic still-image imaging control unit 82) performs a composition process in Step F107.

As the composition process, first, it is determined whether or not the composition at that time point is in the optimal state. In such a case, after the image structure is determined based on the result of the subject detecting process (in this case, determination on the number of subjects within the image frame, the size of each subject, the position of each subject, and the like), an optimal composition is determined based on information on the image structure determined by the image structure determining, by using a predetermined algorithm.

The composition in such a case can be determined based on each imaging field of view of the pan, the tilt, and the zoom. Thus, according to the determination process determining whether or not the composition is the optimal composition, as a result of the determination, information on the control amounts of the pan, the tilt, and the zoom for acquiring the optimal field of view according to the result of the subject detecting process (the status of the subject within the image frame) can be acquired.

Then, when the composition is not in the optimal state, in order to acquire the optimal composition state, as composition combining, the pan/tilt control and the zoom control are performed.

More specifically, the control unit 27 (the automatic still-image imaging control unit 82 and the variable imaging viewing field control unit 83) indicates the information on the change in the control amounts of the pan and the tilt, which is acquired through the optimal composition determining process as composition combining control, to the control unit 51 located on the pan head 10 side.

In accordance with the indication, the control unit 51 of the pan head 10 acquires the movement amounts of the pan mechanism unit 53 and the tilt mechanism unit 56 according to the indicated control amounts and supplies control signals to the pan driving unit 55 and the tilt driving unit 58 so as to perform pan driving and tilt driving for the acquired movement amounts.

In addition, the control unit 27 (the automatic still-image imaging control unit 82 and the variable imaging viewing field control unit 83) indicates the information on the image angle for the zoom that is acquired through the optical composition determining process to the optical system unit 21, whereby performing a zoom operation of the optical system unit 21 so as to acquire the indicated image angle.

In addition, when the composition is determined not to be in the optimal composition state as the composition process, and control of the pan/tilt and the zoom is performed as composition combining, the process is performed again from the subject detecting process of Step F106. The reason for this is that the subject may be deviated from the imaging field of view due to the pan/tilt operation, the zoom operation, or a movement of a person.

When the optimal composition is acquired, the control unit 27 (the automatic imaging mode control unit 86) performs a release timing determining process in Step F108.

In addition, although there is a case where release timing is not “OK” in the release timing determining process in Step F108, in such a case, the process is performed again from the subject detecting process of Step F106. The reason for this is that the subject may be deviated from the imaging field of view or the composition may collapse due to a movement of a subject person or the like.

When the release condition is satisfied through the release timing determining process, automatic recording of the captured image data is performed as the release process of Step F109. More specifically, the control unit 27 (the imaging and recording control unit 81) records the captured image data (frame image) acquired at that time point in the memory card 40 by controlling the encoder/decoder unit 25 and the medium controller 26.

The release timing determining process in Step F108 is a process of determining whether or not a predetermined still-image imaging condition is satisfied for acquiring an appropriate still image, and various examples thereof may be considered.

For example, release timing determining on the basis of time may be considered. For example, an elapse of predetermined time (for example, two or three seconds) from the time point at which the composition process is “OK” may be used as the still-image imaging condition. In such a case, the control unit 27 (the automatic imaging mode control unit 86) counts predetermined time in Step F108, and the control unit 27 (the imaging and recording control unit 81) performs the release process in Step F109 in accordance with the elapse of the predetermined time.

In addition, in a case where a specific subject state is determined from the captured image, the still-image imaging condition may be determined to be satisfied.

The control unit 27 (the automatic imaging mode control unit 86) monitors the specific subject state that is detected through analysis of the captured image in Step F108.

As the specific subject state, a state in which a subject perceived through the composition process has a specific facial expression such as a smiling face, a state in which the subject makes a specific gesture such as waving his or her hand toward the imaging system, raising his or her hand, clapping his or her hands, giving a piece sign, or winking at the imaging system may be considered. Alternatively, a state in which a user as a subject watches the imaging system or the like may be considered.

The control unit 27 determines the user's specific state through the image analyzing process of the captured image in Step F108. Then, when the specific subject state is detected, the release timing is determined, and the release process is performed in Step F109.

In addition, in a case where the digital still camera 1 includes the audio input unit 35, when there is a specific audio input, the still-image imaging condition may be determined to be satisfied.

For example, a specific term spoken by a user, a sound of clapping hands, a sound of whistle, or the like is the specific sound as the still-image imaging condition. The control unit 27 (the automatic imaging mode control unit 86) detects an input of such a specific sound in Step F108.

When such a specific sound is checked based on the result of analysis of the audio signal input from the audio input unit 35, the control unit 27 determines the release timing, and the release process is performed in Step F109.

By repeating the process of the above-descried Steps F106 to F109, a plurality of still images is automatically captured.

Then, when the automatic still-image imaging is determined to end in Step F105 in accordance with a predetermined end trigger such as an operation of the user, the process of the control unit 27 proceeds to Step F114, an automatic imaging operation completing process is performed, and a series of operations in the automatic imaging mode is completed.

In a case where the automatic panorama imaging is selected and set, the process of the control unit 27 proceeds to Step F110 from Step F102.

In Step F110, the control unit 27 (the automatic panorama imaging control unit 84) sets parameters, algorithms, and the like for the automatic panorama imaging operation. For example, the control unit 27 sets a maximum tilt angle, panning speed, the algorithm of the subject detecting composition process, the conditions for release timing, and the like.

After performing various control settings for the automatic panorama imaging operation, the control unit 27 actually performs a control process of the automatic panorama imaging operation.

In the automatic panorama imaging, the imaging system of this example automatically acquires a plurality of frame image data while automatically performing panning with a predetermined angle, and, by composing theses, an operation for generating the panorama image data is performed.

When an imaging operation is started in the automatic panorama imaging mode, first, captured image data is started to be captured in Step F111.

In other words, the control unit 27 (the imaging and recording control unit 81) starts to capture the captured image data for each frame by using the image sensor 22 and the signal processing unit 24.

Thereafter, until the automatic panorama imaging operation is determined to end in Step F113, the panorama imaging process of Step F112 is performed.

A concrete example of the panorama imaging process of Step F112 will be described later as Examples I to V of the panorama imaging process.

In a case where the panorama imaging operation is set to be completed after the panorama imaging operation is performed once as the automatic imaging mode, the end of the panorama imaging operation is determined in Step F113, and the control unit 27 performs a completion process of the automatic imaging mode operation in Step F114.

On the other hand, in a case where the panorama imaging operation is set to be repeated as the automatic imaging mode, the process is returned to Step F112 from Step F113, and the panorama imaging operation is repeated. Then, when there is an end operation of the user or a set number of the panorama imaging operations is completed, the end of the panorama imaging operation is determined in Step F113, and the control unit 27 performs the completion process of the automatic imaging mode operation in Step F114.

The automatic still-image imaging operation and the automatic panorama imaging operation as the automatic imaging mode are, for example, performed as presented above.

### [4-2: Second Example of Automatic Imaging Process]

A second example of the automatic imaging process will be described with reference to FIG. 12.

This second example of the automatic imaging process basically performs the automatic still-image imaging operation when the operation is started as the automatic imaging mode. Then, in this example, the automatic panorama imaging operation is performed by a trigger during the process of the automatic still-image imaging operation.

FIG. 12 shows the process of the control unit 27 of the digital still camera 1 that is performed by the mechanism configuration shown in FIG. 9.

When a user directs to perform an automatic imaging operation through a predetermined operation, the control unit 27 (the automatic imaging mode control unit 86) advances the process from Step F201 to Step F202 and sets parameters, algorithms, and the like for the automatic still-image imaging operation.

After performing various control settings for the automatic still-image imaging operation, the control unit 27 performs an actual control process of the automatic still-image imaging operation.

First, captured image data is started to be captured in Step F203.

In other words, the control unit 27 (the imaging and recording control unit 81) starts to capture the captured image data for each frame by using the image sensor 22 and the signal processing unit 24.

Thereafter, until the automatic imaging mode operation is determined to end in Step F204, the process of Steps F205 to F209 is performed.

The control unit 27 (the automatic imaging mode control unit 86) checks whether or not a trigger for performing a panorama imaging process occurs in Step F205.

Steps F206 to F209, similarly to Steps F106 to F109 shown in FIG. 11, correspond to a process for the automatic still-image imaging operation. Since description will be duplicate, detailed description is omitted here. By repeating the process of Steps F206 to F209, imaging of a plurality of still images is automatically performed.

Then, when the end of the automatic imaging mode operation is determined in Step F204 in accordance with a predetermined end trigger such as a user's operation, the process of the control unit 27 proceeds to Step F213, a completion process of the automatic imaging operation is performed, and a series of operations of the automatic imaging mode end.

In the process of performing the automatic still-image imaging operation, the control unit 27 (the automatic imaging mode control unit 86) recognizes a predetermined situation as a trigger for a panorama imaging process in Step F205.

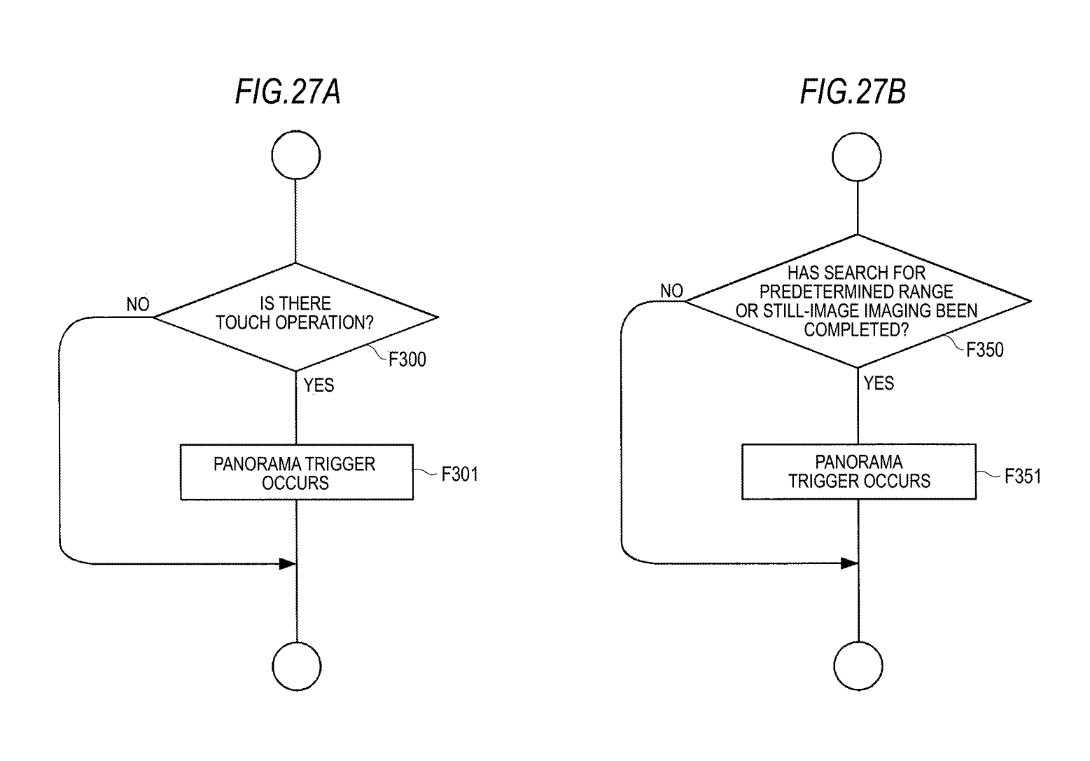

Examples of the trigger for performing the automatic panorama imaging process will be described with reference to FIGS. 27A to 30B.

When the control unit 27 (the automatic imaging mode control unit 86 and the automatic panorama imaging control unit 84) determines an occurrence of a trigger for performing the panorama imaging process at a time point during the process of the automatic still-image imaging operation, the process proceeds to Step F210. Then, the control unit 27 (the automatic panorama imaging control unit 84) sets parameters, algorithms, and the like for the automatic panorama imaging operation in Step F210. For example, the control unit 27 sets a maximum tilt angle, panning speed, the algorithm of the subject detecting composition process, the conditions for release timing, and the like.

After performing various control settings for the automatic panorama imaging operation, the control unit 27 actually performs a control process of the automatic panorama imaging operation in Step F211.

A concrete example of the panorama imaging operation of Step F211 also corresponds to Examples I to V of the panorama imaging process to be described later.

When the panorama imaging process is completed, the parameters, the algorithms, and the like for the automatic still-image imaging operation are set (the same settings as in Step F202) in Step F212. Then, the process is returned to Step F204, and the control unit 27 resumes the automatic still-image imaging process.

As above, the automatic still-image imaging operation and the automatic panorama imaging operation as the automatic imaging mode are performed.

In the first and second examples of the automatic imaging process, the process performed in the imaging system configured by the digital still camera 1 and the pan head 10 has been described. However, the above-described operations can be performed by a digital still camera in which variable imaging viewing field mechanism is integrally installed as the pan/tilt mechanism.

### <5. Panorama Imaging Process>

### [5-1: Process Example I]

Hereinafter, in this embodiment, Process Examples I to V of the panorama imaging process will be described. Each of the Process Examples I to V is the process of the control unit 27 in Step F112 shown in FIG. 11 or Step F211 shown in FIG. 12. In addition, each of the Process Examples I to V is a process basically performed based on the function of the automatic panorama imaging control unit 84 of the control unit 27. The driving of the pan, the tilt, and the zoom and the determination on the composition according to the driving of the pan, the tilt, and the zoom are realized by supplying a pan/tilt control signal to the pan head 10 and controlling the driving of the zoom mechanism using the variable imaging viewing field control unit 83 based on a direction of the automatic panorama imaging control unit 84. In addition, the imaging operation is performed by controlling the imaging system by using the imaging and recording control unit 81 based on a direction of the automatic panorama imaging control unit 84.

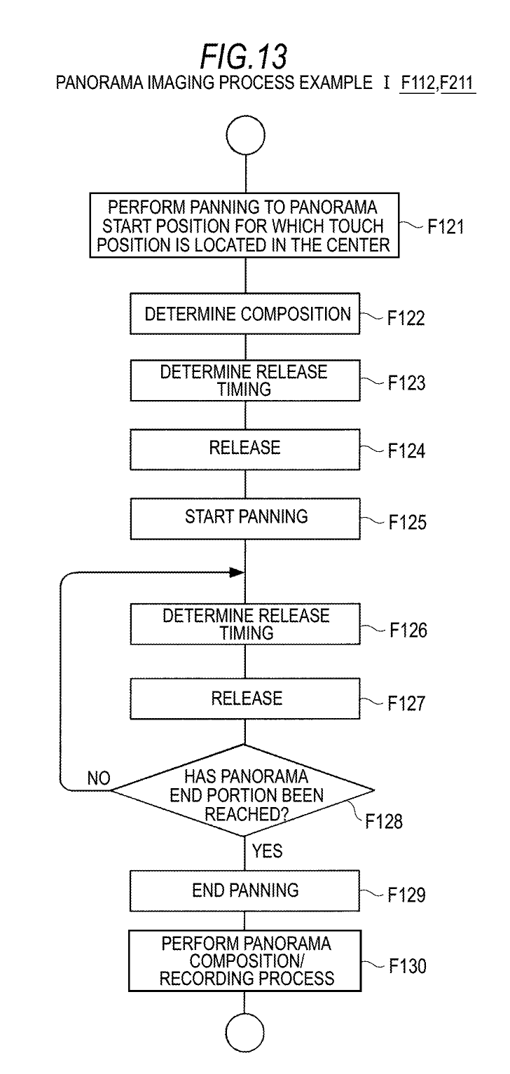

First, Process Example I will be described with reference to FIGS. 13, 14, 15A, and 15B.

This process example is a process example corresponding to a user's touch operation for the pan head 10 described with reference to FIGS. 6A and 6B.

More specifically, this Process Example I can be regarded as a process in a case where, in the second example of the automatic imaging process shown in FIG. 12, an occurrence of a trigger for performing panorama is determined in Step F205 when the control unit 27 recognizes a user's touch operation for the pan head 10, and the process proceeds from Step F210 to Step F211. The control unit 27 can recognize the user's touch operation for the pan head 10 by communicating with the pan head 10 (the input recognizing unit 73->the communication processing unit 71->the communication processing unit 85).

In addition, Process Example I can be regarded as a process in a case where, even in a case where the first example of the automatic imaging process shown in FIG. 11, panorama imaging of Step F112 is performed in accordance with a user's touch operation.

Here, Process Example I of panorama imaging as Step F112 or F211 is shown in FIG. 13.

First, the control unit 27 performs panning control for realizing a panorama composition in which the touch position is located in the center as Step F121 shown in FIG. 13. In other words, within the angle range for which panorama imaging is performed, the user's touch position is controlled to be located in the center in the horizontal direction. In other words, a composition is set in which the user's touch position is used as the horizontal position relating to the operation, and the position becomes the center of the panorama image.

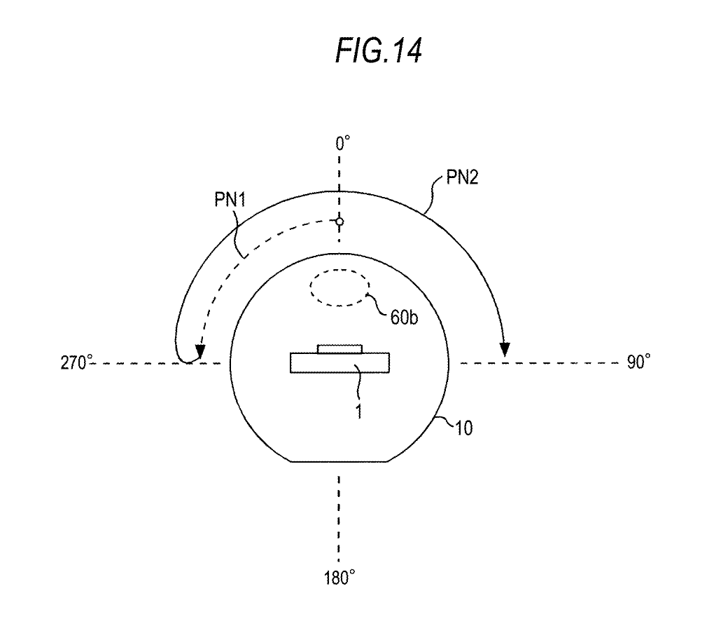

In the example shown in FIG. 6A, an example in which the touch region 60b is arranged on the front face side of the pan head 10 has been described. A specific operation will be described with reference to FIG. 14 based on this example.

FIG. 14 shows the pan head 10 and the digital still camera 1. Here, the direction of the viewing field of the digital still camera 1 at a time point when the user touches the touch region 60b is assumed to be 0° at the position in the horizontal direction. In addition, it is assumed that panorama imaging is performed within the angle range of 180°.

The touch region 60b is located on the front face side of the pan head 10 and is located at a position at 0° direction.

Thus, first, the control unit 27 performs panning control of 90° rotation in the counter clockwise direction as denoted by a broken-line arrow PN1. In accordance with this panning, the position at 270° becomes the direction of the viewing field of the digital still camera 1.

The control unit 27, first, performs such panning control in Step F121. Then, the position at 270° becomes the start position of panorama imaging.

Next, the control unit 27 determines a composition in Step F122.

The composition in the panning direction is determined through the control performed in Step F121. In addition, the tilt angle is adjusted. The zoom magnification rate may be set. Alternatively, in the panorama imaging operation, the tilt setting and the zoom setting may not be performed. In other words, it may be configured that the composition is determined through the panning performed in Step F121, and the process proceeds.

When the composition is determined, actual panorama imaging operation is started. First, the control unit 27 determines release timing in Step F123 and controls performing of the release under a predetermined condition in Step F124.

In other words, in the composition state determined at the start position of panorama, the first frame image data corresponding to one frame is acquired.

The determination of the release timing in this case, as described in Step F208 shown in FIG. 11, may be performed based on a smiling face, a specific behavior, a specific sound, or the like of a subject. However, in the case of panorama imaging, since there are cases where a person or the like as a subject does not exist at the start position of panorama imaging, the release timing may be appropriately determined instantly after the determination of the position. In other words, such a case is an example in which completion of determination of the composition is determined to satisfy the condition for the release timing.

In addition, the release in the case of panorama imaging represented in FIG. 14 does not mean up to recording of still-image data but means acquisition of image data to be synthesized.

Subsequently, the control unit 27 directs the pan head 10 side to start panning in Step F125.

In the example shown in FIG. 14, panning from the position at 270° in the clockwise direction denoted by a solid-line arrow PN2 is performed.

After panning is started, the control unit 84 determines release timing in Step F126 and performs release control in Step F127. This is repeated until reach at the end position of panorama in Step F128.

In other words, release timing is determined while performing panning, and frame image data is sequentially acquired.

The release timing determining in Step F126 is considered to be controlled, for example, for each predetermined time interval, for each predetermined panning angle, or the like.

In a case where panorama imaging is set to be performed with 180° panning as shown in FIG. 14, the control unit 27 determines the reach at the end position of panorama at a time point when panning up to the 90° position shown in FIG. 14 is performed. In other words, it is determined that 180° panning is completed.

At this time, the control unit 27 directs the pan head 10 side to end the panning in Step F129.

In addition, in Step F130, the control unit 27 controls performing a synthesis process for a plurality of frame image data acquired until then and recording the synthesized panorama image data in the memory card 40.

As above, the panorama imaging process as Step F211 shown in FIG. 12 or Step F112 shown in FIG. 11 is completed.

According to such panorama imaging operation control, a panorama image in which a person demanding panorama imaging is transferred in the center is acquired.

In other words, when the user touches the touch region 60b of the pan head 10 in a case where the digital still camera 1 is appropriate to the user, first, panning for swinging in the counterclockwise direction is performed, and then, panorama imaging for a predetermined angle range is performed. The user who has performed the touch operation is approximately in the center of the angle range for which panorama imaging is performed. Accordingly, a panorama image having a composition that is the most favorable to a person who has demanded panorama imaging is acquired.

In Process Example I as above, in a case where the panorama imaging process is performed in accordance with the trigger on the basis of a user operation, the start position and the end position of the panorama imaging process are determined such that the horizontal position at which the user operation is performed is in the center of a panorama image. Accordingly, an automatic panorama imaging process for an appropriate composition is realized.

In the example shown in FIG. 14, the panorama imaging operation has been described to be performed in the range of 180°. However, in a case where the panorama imaging operation is set to be performed in the range of 360°, the panning of Step F121 is performed up to a 180° position. Then, in Step F125 and thereafter, panning of one circle is performed with the 180° position, shown in FIG. 14, set as the start position of the panorama imaging operation.

In other words, it is preferable that panning up to the start position of the panorama imaging operation in Step F121 may be performed in the range of a half of the angle range for which the panorama imaging operation is performed.

In FIG. 6B, an example in which three touch regions 60b, 60c, and 60d are formed in the pan head 10 is shown. A process example in such a case may be performed as below. The angle range of the panorama imaging operation is described as 180°.

First, when a user touches the touch region 60b, the process is as shown in FIG. 14.

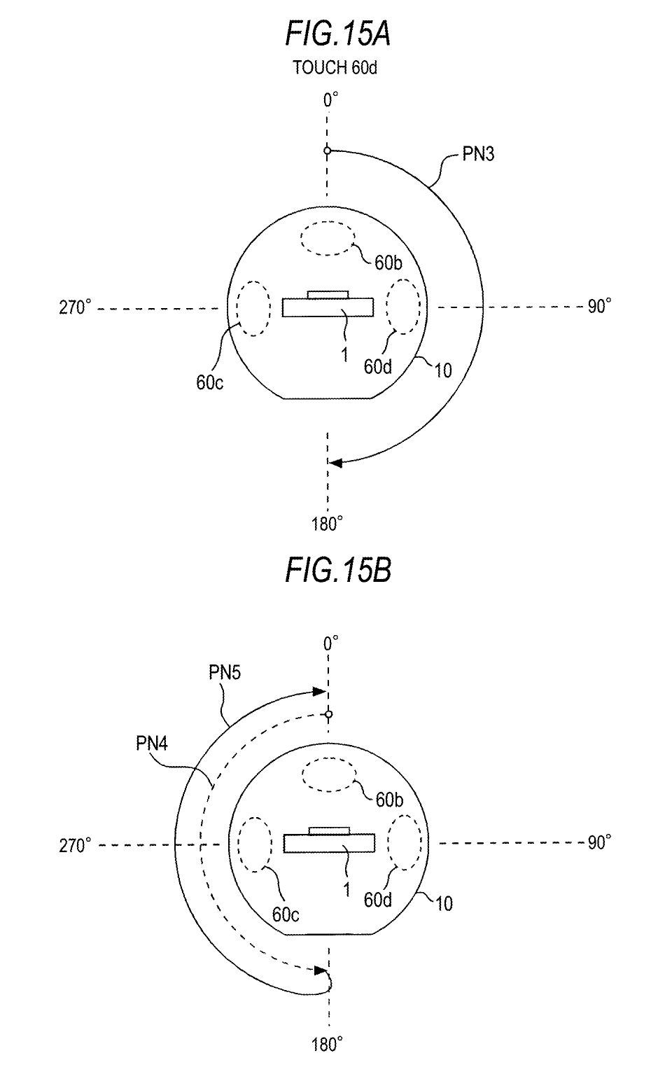

A case where the user touches the touch region 60d is shown in FIG. 15A. Similarly to FIG. 14, when the direction of the viewing field of the digital still camera 1 at the start time point of the touch operation is assumed as 0°, the touch region 60b corresponds to a 90° position shown in FIGS. 15A and 15B.

When the angle range of the panorama imaging operation is assumed as 180°, a 0° position corresponds to a start position for locating the direction of 90° in the center of a panorama image. Thus, in such a case, actual panning control of Step F121 is not necessary. The reason for this is that it can be regarded that the operation of Step F121 is completed at the start time point of the touch operation.

Then, in Step F125 and thereafter, as denoted by a solid-line arrow PN3, the panorama imaging operation may be performed while performing 180° panning control up to a 180° position.

As a result, a panorama image having a composition in which the user who has performed the touch operation located in the direction of 90° is in the center is acquired.

Next, a case where the user touches the touch region 60c will be described with reference to FIG. 15B. The touch region 60c corresponds to a 270° position shown in FIGS. 15A and 15B.

When the angle range of the panorama image operation is 180°, in order to locate the position (270° position) of the touch region 60c in the center of a panorama image, it is necessary that the start position of the panorama imaging operation is the 180° position.

Accordingly, in such a case, in Step F121, panning control denoted by a broken-line arrow PN4 is performed.

In addition, as panning control in the clockwise direction, the start position of the panorama imaging operation may be the 180° position.

Then, in Step F125 and thereafter, as denoted by a solid-line arrow PN5, the panorama imaging operation may be performed while performing panning control of the 180° angle range from the 180° position to the 0° position.

As a result, a panorama image having a composition in which the user who has performed the touch operation located in the direction of 270° is in the center is acquired.

In other words, as the process of Step F121 shown in FIG. 13, the amount of panning control may be determined in accordance with the position of the user who has performed the touch operation and the angle range of the panorama imaging operation.

The same applies also to a case where more touch regions are arranged in the pan head and the user's position can be delicately estimated, the same applies.

Although an example in which the touch sensor is mounted on the pan head 10 has been described, there is a case where a touch sensor unit is formed in the casing of the digital still camera 1. Also in such a case, when the direction in which an operating user is located can be estimated, the panning control of Step F121 as described above may be considered to be performed. On the other hand, in a case where it is difficult to estimate the direction in which the user is located, it may be configured that the user is estimated to perform the touch operation from the viewing field direction of the digital still camera 1 at that time point, and the operation as shown in FIG. 14 is performed.

In addition, in a case where the touch sensor is arranged on the digital still camera 1 side, the control unit 27 (the input recognizing unit 88) recognizes a touch operation.

In addition, as above, the process example in which the position of the user is estimated based on the touch operation has been described. However, to a case where the user's position can be estimated other than the above-described example, Process Example I can be applied.

For example, in a case where, when a specific sound acquired by the audio input unit 35 (or 62) is recognized, the direction of the user who has generated the sound can be estimated, the panning control of Step F121 may be performed such that the direction is in the center of a panorama image.

In addition, in a case where an exciting situation is estimated, for example, when the volume of sound increases, and the increase in the volume of sound is used as a trigger for the panorama imaging operation, in order to locate the direction of the sound is in the center of a panorama image, the panning control of Step F121 may be considered to be performed.

In addition, there is a case where a specific pose, a behavior, a gesture, or the like of a user is recognized as a trigger for the panorama imaging operation. This is a case where the trigger is determined to occur in Step F205 shown in FIG. 12 in a case where a specific pose or the like is detected through analysis of an captured image signal.

In such a case, since the user who has shown a specific pose or the like is in the direction of the viewing field of the digital still camera 1, through the process represented in FIG. 13, the panning control as shown in FIG. 14 is performed In Step F121, and then the panorama imaging operation is started. Then, a panorama image having a composition in which the user is in the center is acquired.

### [5-2: Process Example II]

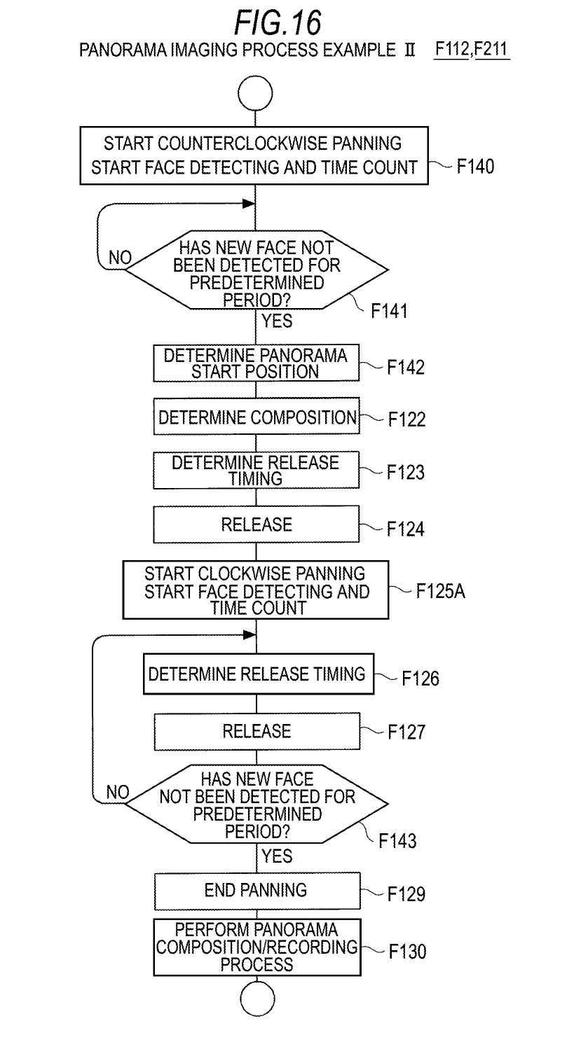

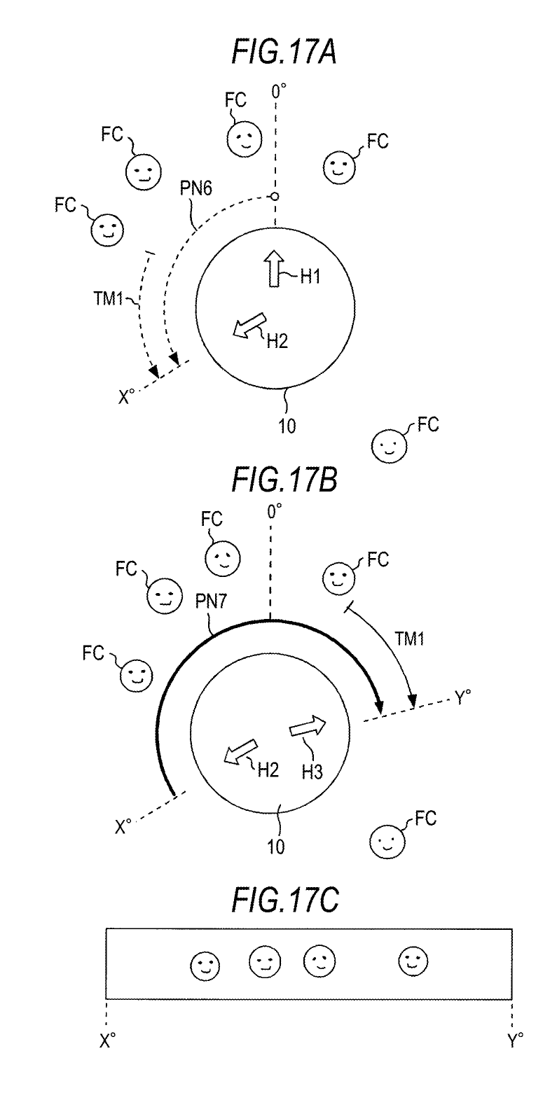

Subsequently, Process Example II of panorama imaging as Step F112 shown in FIG. 11 or Step F211 of FIG. 12 will be described with reference to FIG. 16 and FIGS. 17A to 17C.

This Process Example II is a process in which the start position and the end position of the panorama imaging operation are determined based on the determination of existence of a predetermined target subject (for example, a human face) that is recognized based on the captured image signal acquired though imaging.

FIG. 16 shows the process of the control unit 27 as Process Example II. The same reference numeral is assigned to the same process as the above-described process shown in FIG. 13, and detailed description thereof is omitted.

When the process proceeds to Step F112 shown in FIG. 11 or Step F211 shown in FIG. 12, the control unit 27 performs the process shown in FIG. 16.

The control unit 27, first, starts a process of performing face detection while performing counterclockwise panning control in Step F140. In such a case, the control unit 27 checks whether a face image exists by analyzing captured image data acquired by imaging during the panning process.

In addition, the control unit 27 starts time count as the start time point of face detection of Step F140.

When a new face is not detected for a predetermined period, the process proceeds from Step F141 to Step F142, and the position in the horizontal direction at that time is determined as the start position of the panorama imaging operation.

FIGS. 17A to 17C show operation examples. The direction of the viewing field of the digital still camera 1 at the start time point of the process shown in FIG. 16 is denoted by an arrow H1. The direction of the arrow H1 is assumed as 0°.

First, as the control unit 27 directs the counterclockwise panning in Step F140, the pan head 10 starts counterclockwise panning as denoted by a broken-line arrow PN6 shown in FIG. 17A. At this time, the control unit 27 checks whether or not a new face is detected from the left side of the imaging viewing field by continuing to perform face detection. Although the control unit 27 starts time count from the start point of the panning, this time count is reset at a time point when a new face is detected, and counting is restarted.

Like a face FC shown in the figure, when there is a user in the surrounding area, after start of panning denoted by a broken-line arrow PN6, from the first person to the third person, faces FC thereof are detected in relatively short time. However, after the face FC of a third person is detected, the face FC of a fourth person is hardly detected. Here, after the face FC of the third person is detected, at a time point when the direction of the viewing field is the direction denoted by an arrow H2, time TM1 as a period during which a new face is not detected has elapsed.

In Step F141, such an elapse of time TM1 is determined as an elapse of a predetermined period.

Then, in Step F142, the position at this time, that is, the position of X° in the horizontal direction that is shown in FIG. 17A is set as the start position of the panorama imaging operation.

As above when the start position of the panorama imaging operation is determined, the control unit 27, similarly to the above-described case of FIG. 13, determines a composition in Step F122, performs release timing determining in Step F123, and performs the first release control process in Step F124.

Then, in Step F125A, clockwise panning for the panorama imaging operation is started.

For example, panning denoted by an arrow PN7 from the position X° shown in FIG. 17B is started.

Here, even after the start of the panning for the panorama imaging operation as above, the control unit 27 performs face detection and time count. In other words, the control unit 27 checks whether or not a new face is detected from the right side of the viewing field during the panning denoted by the arrow PN7 by continuing to perform face detection. In addition, after starting the clockwise panning denoted by the arrow PN7, the control unit 27 starts time count from the time point when the first face detection time point. This time count is reset at a time point when a new face is detected, and counting is restarted.

During the clockwise panning process denoted by this arrow PN7, the control unit 27 determines release timing in Step F126 and performs release control in Step F127, that is, acquisition of frame image data for generating a panorama image. For example, the release control is performed for predetermined time, for each predetermined panning angle, or the like.

In addition, in Step F143, it is checked whether or not a new face has not been detected for a predetermined period.

In the example shown in FIG. 17B, after start of the panning denoted by the arrow PN7, from the first person to the fourth person, faces FC are detected in relatively short time. However, after the face FC of the fourth person is detected, the face FC of a fifth person is hardly detected. Here, after the face FC of the third person is detected, at a time point when the direction of the viewing field is the direction denoted by an arrow H3, it is assumed that time TM1 as a period during which a new face is not detected has elapsed.

In Step F143, such an elapse of time TM1 is determined as an elapse of a predetermined period.

In the case where the predetermined period elapses, the process proceeds to Step F129, and the panning process of the pan head 10 side for the panorama imaging operation is completed. In other words, the position of Y° in the horizontal direction, shown in FIG. 17B, is set as the end position of the panorama imaging operation.

In addition, the control unit 27, in Step F130, controls performing a synthesis process for a plurality of frame image data acquired until then and a recording operation of the synthesized panorama image data in the memory card 40.

As above, the panorama imaging process as Step F112 shown in FIG. 11 or Step F211 shown in FIG. 12 is completed.

In other words, in this Process Example II shown in FIG. 16, first, before start of the panorama imaging operation, the control unit 27 (the automatic panorama imaging control unit 84) analyzes the captured image signal while the variable imaging viewing field control unit 83 allows the pan head 10 to perform panning. Then, the control unit 27 sets the position of the viewing field at a time when the target subject (face image) is determined not to exist for a predetermined time as the start position of the panorama imaging operation.

Furthermore, the control unit 27 (the automatic panorama imaging control unit 84), in the middle of performing the panorama imaging operation, sets the position of the imaging viewing field at a time when the target subject (face image) is determined not to exist for the predetermined time based on the captured image signal as the end position of the panorama imaging operation.

As above, by determining the start position and the end position of the panorama imaging operation based on the detection of a face from the captured image, an automatic panorama imaging operation having an appropriate composition is realized.

For example, according to the operations shown in FIGS. 17A and 17B, a panorama image having a composition as shown in FIG. 17C is acquired. This image is an image in which a plurality of users are aligned with the image center used as the center thereof, and there is no person in both ends thereof. In other words, since portions in which there is no person as set as both ends of a panorama image, a panorama image having a balanced composition is acquired.

In addition, in Steps F141 and F143, an elapse of the predetermined period is described to be detected based on time count of time TM1. However, the panning movement of a predetermined angle range may be detected not by counting time but by monitoring the control amount of panning. In other words, it is monitored whether or not panning of a predetermined angle is performed with any face not detected.

In Steps F142 and F143, although the time TM1 is used, different time may be monitored.

In addition, in a case where the time is monitored, it is appropriate that a time value of a predetermined period is set in accordance with the speed of panning (a broken-line arrow PN6) up to the start position of the panorama imaging operation and the speed of panning (arrow PN7) during the panorama imaging operation.

However, in order to form a composition in which images of persons are disposed in a balanced manner by opening both ends thereof, it is preferable that the same time value is monitored in Steps F141 and F143 in a case where panning speed is constant.

Although, the target subject has been described as a face, a specific subject other than a face may be considered to be set as the target subject.

In addition, although a case where the panorama imaging operation is performed while performing panning has been assumed and described, for example, a case where the panorama imaging operation is performed in the vertical direction while performing tilting may be considered. In such a case, a process in which the start position and the end position of the panorama imaging operation are determined by performing determination of existence of the target subject while performing tilting can be performed.

### [5-3: Process Example III]

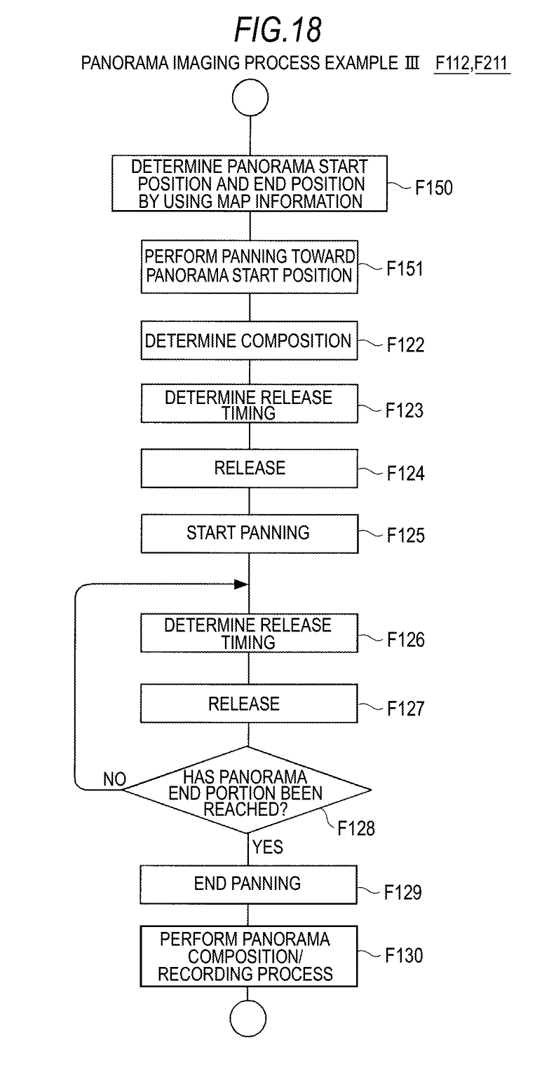

Process Example III of the panorama imaging that can be applied to Step F112 shown in FIG. 11 or Step F211 shown in FIG. 12 will be described with reference to FIGS. 18, 19A, 19B, 20A, 20B, 21A, and 21B.

This Process Example III is a process in which the start position and the end position of the panorama imaging operation are determined based on imaging history information that represents the existence of a predetermined target subject that is generated based on the captured image signals acquired in the past.

Particularly, in this example, the control unit 27 determines a distribution of existence of a target subject (for example, a face) by referring to face detection map information that is acquired based on the imaging history information. Then, in accordance with the distribution of existence, the start position and the end position of the panorama imaging operation are determined.

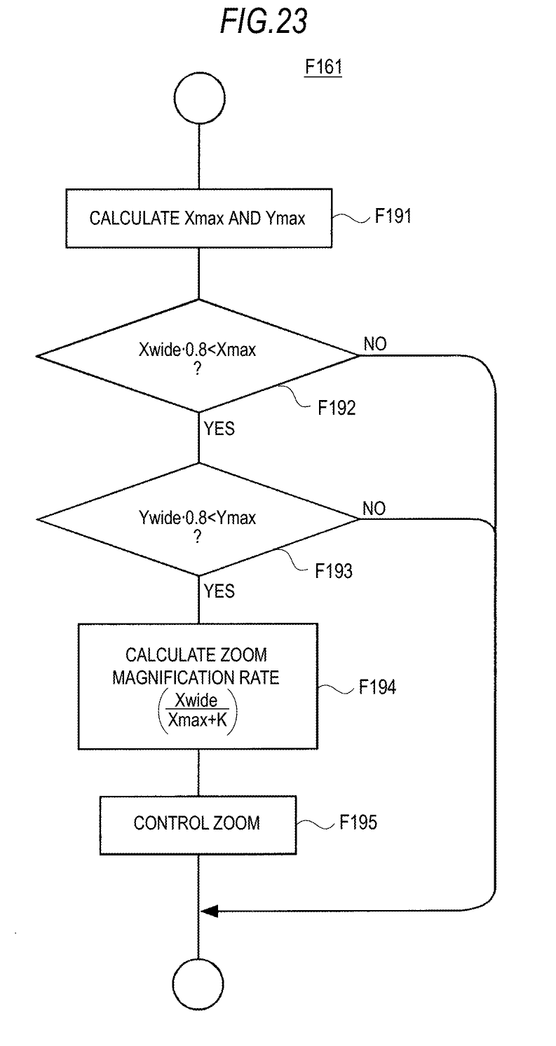

First, the imaging history information and the face detection map information will be described with reference to FIG. 23.

For example, in Step F109 shown in FIG. 11 or Step F209 shown in FIG. 12, when release, that is, an imaging and recording operation of a still image is performed, the control unit 27 (the imaging history information managing unit 87) performs a process in which various types of information at the time of the imaging and recording operation is stored, for example, in the RAM 29 or the flash memory 30.

The stored information becomes the contents of the imaging history information.

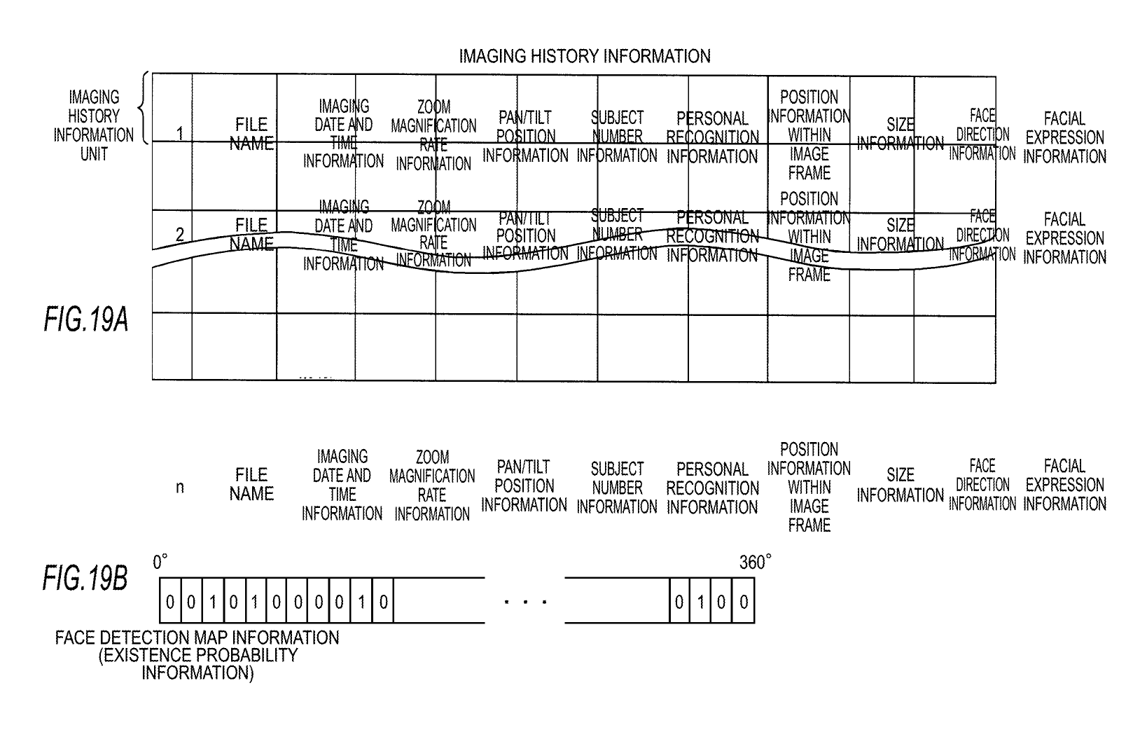

An example of the contents of the imaging history information will be described with reference to FIG. 19A.

The imaging history information is formed by a set of imaging history information units 1 to n. One imaging history information unit stores history information corresponding to automatic imaging and recording performed once therein.

One imaging history information unit, as shown in the figure, includes a file name, imaging date and time information, zoom magnification rate information, pan/tilt position information, subject number information, personal recognition information, position information within an image frame, size information, face direction information, facial expression information, and the like.

The file name represents a file name of captured image data that is recorded as a file in the memory card 40 through the automatic still-image imaging and recording. Instead of the file name, a file path or the like may be used. In any case, based on the information of the file name or the file path, an imaging history information unit and captured image data stored in the memory card 40 can be associated with each other.

The imaging date and time information represents the date and time at which corresponding automatic still-image imaging and recording are performed.

The zoom magnification rate information represents the zoom magnification rate at the time of imaging and recording (releasing).

The pan/tilt position information represents a pan/tilt position that is set when corresponding automatic imaging and recording is performed.

The subject number information represents the number of subjects (detected individual subjects) that exist within corresponding captured image data, that is, an image (image frame) of captured image data that is stored in the memory card 40 through a corresponding automatic imaging and recording operation.

The personal recognition information is information of a personal recognition result (personal recognition information) of each subject existing within an image of the corresponding captured image data.

The position information within an image frame is information representing the position of each subject existing within corresponding captured image data within an image frame. For example, this position information within an image frame can be represented as coordinate position of a point corresponding to the center acquired for each subject within an image frame.

The size information is information representing the size of each subject existing within an image of corresponding captured image data within an image frame.

The face direction information is information representing the direction of the face detected for each subject existing within an image of corresponding captured image data.

The facial expression information is information representing the expression (for example, an identification of a smiling face, a non-smiling face, or the like) detected for each subject existing within an image of corresponding captured image data.

For example, for each release processing time point in an automatic still-image imaging process, the imaging history information unit having such contents is stored. Then, by maintaining the imaging history information units as imaging history information, various processes can be performed. In this embodiment, in the panorama imaging operation, the imaging history information is used as below.

First, the control unit 27 (the imaging history information managing unit 87) generates face detection map information as shown in FIG. 19B based on the imaging history information. This is information that represents whether or not a user (face) exists (is estimated to exist) at each angle position by dividing, for example, a surrounding 360° range of the pan head 10 for each predetermined angle.

For example, face detection map information is generated by setting an existence flag “1” on a map for each angle position at which a person is determined to exist by referring to the pan/tilt position information or the position information within an image frame of each imaging history information unit.

However, the user position is not consistently fixed due to movements of surrounding persons. Accordingly, the face detection map information is not necessarily an accurate map at the current time point. In other words, the face map information is information of angle positions at which a user is estimated to exist unless the user moves thereafter. Thus, in order to improve the accuracy of estimation, the face detection map information may be considered to be sequentially updated, so that only the imaging data and time information of the imaging history information unit that is within predetermined time from the current time is reflected.

Alternatively, the face detection map information may be generated only with the imaging history information unit at the release time point during a latest period during which a face search at the time of the automatic still-image imaging operation is performed in the 360° range.

By referring to such face detection map information, the distribution of existence of a user in the surrounding area can be estimated at the time of the panorama imaging operation. Thus, the control unit 27 performs a process shown in FIG. 18 as the panorama imaging process.

At the start of the panorama imaging process, first, the control unit 27 determines the start position and the end position of the panorama imaging operation by referring to the face detection map information in Step F150 shown in FIG. 18.

Then, in Step F151, the control unit 27 performs panning control at the start position of the panorama imaging operation.

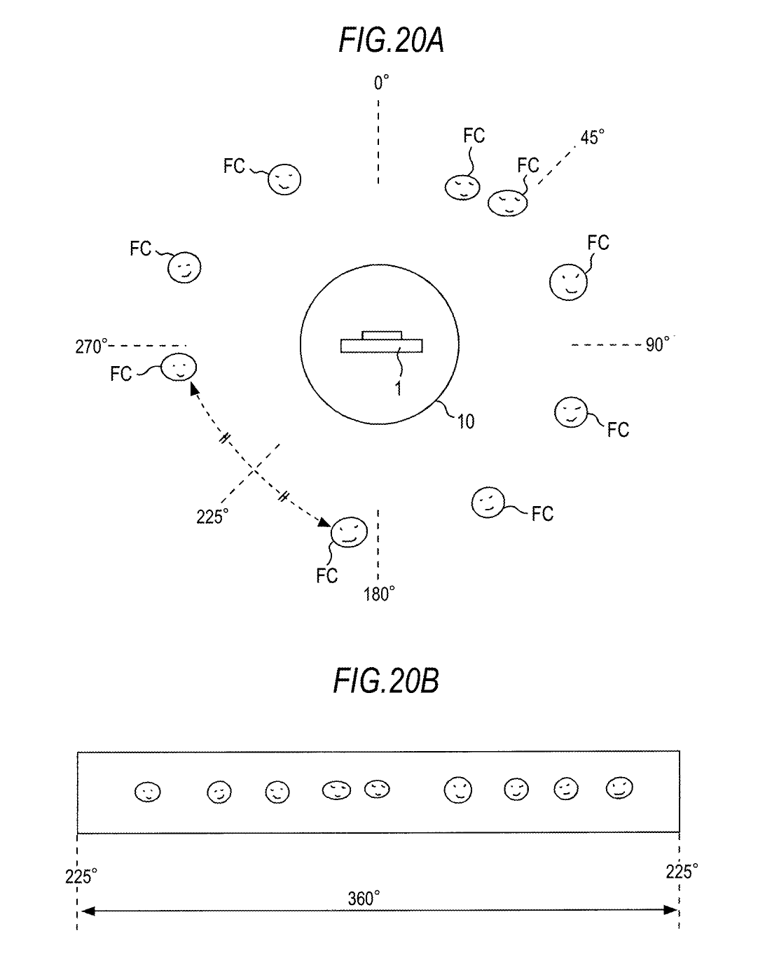

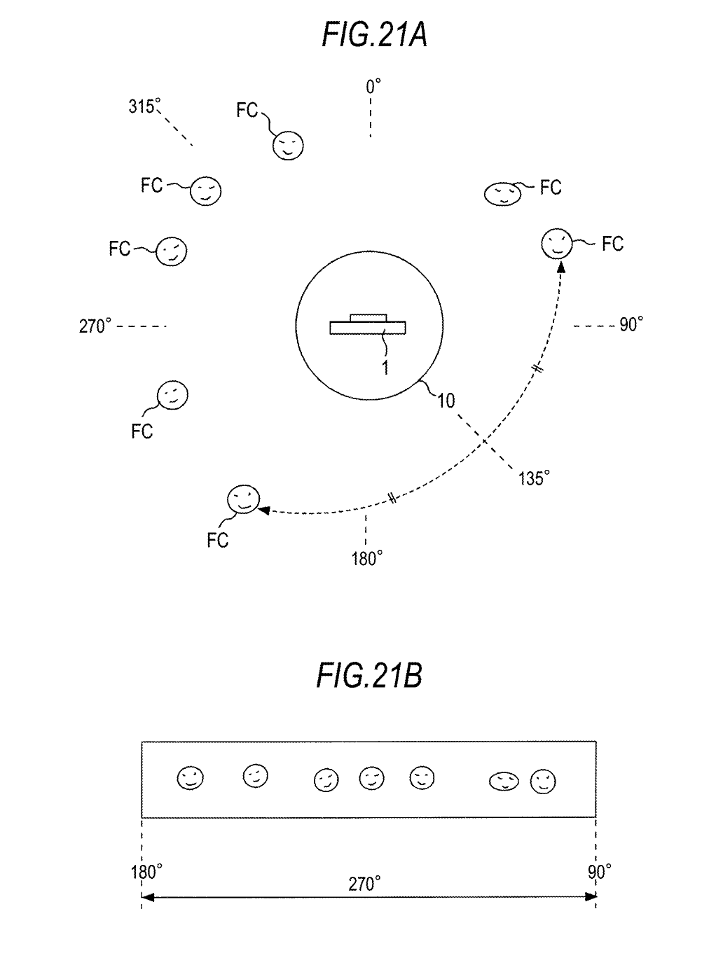

Now, operation examples of Steps F150 and F151 will be described with reference to FIGS. 20A, 20B, 21A, and 21B.

The angle position shown in FIGS. 20A, 20B, 21A, and 21B corresponding to the angle position of the face detection map information. The control unit 27 perceives the direction of a reference position (see FIG. 4) as a pan position as 0°, generates the face map information, and estimates the existence of the surrounding persons.

It is assumed that many users exist in the surrounding area of the digital still camera 1 and the pan head 10. Then, based on the above-described face detection map information, for example, as in FIG. 20A, the existence of a face FC is estimated at each surrounding angle position.

In such a case, the control unit 27 sets the center of a portion in which a distance between faces FC and FC is the longest as the corner of a panorama image. In other words, the control unit 27 sets a combined center such that the center point of the portion in which the distance between the faces FC and FC are the longest becomes the corner of the panorama image.

In a case where the panorama imaging operation is performed in a 360° range, the start position and the end position of the panorama imaging operation become the same angle position. In the case shown in FIG. 20A, based on the face detection map information, the position at 225° shown in the figure is determined as the center of a portion in which a distance between the faces FC and FC is the longest. In order to arrange the position at 225° in the corner of the panorama image, the combined center may be a position at 45°.

In such a case, the control unit 27 determines the position at 225° as the start position and the end position of the panorama imaging operation.

In addition, an example in a case where the panorama imaging operation is performed in a 270° range is shown in FIG. 21A. In a case where the situation shown in FIG. 21A is estimated based on the face detection map information, a position at 135° shown in the figure is determined as the center point of a portion in which a distance between the faces FC and FC is the longest.

In such a case, the control unit 27 determines the start position and the end position of the panorama imaging operation such that the position at 135° becomes the center of the angle range (the remaining range of 90°) that is not included in a panorama image of the 270° range. In other words, the control unit 27 arranges the position at 315° shown in the figure as the combined center.

In this example, it may be configured that a position at 180° is set as the start position of the panorama imaging operation, and a position at 90° is set as the end position of the panorama imaging operation.

In Step F150, the start position and the end position are determined as above, panning for returning to the start position is performed in Step F151, and the panorama imaging operation is performed in the process of Step F122 and thereafter. Since Steps F122 to F130 are the same as those shown in FIG. 13, the description thereof is omitted.

In addition, it is apparent that the panorama end position determined in Step F128 becomes the panorama end portion that is determined based on the face detection map information in Step F150.

According to such a process, a panorama image having a good balance is acquired in the automatic panorama imaging operation.

For example, when the panorama imaging operation is performed in the range of 360° by determining the start position and the end position as described with reference to FIG. 20A, a panorama image as shown in FIG. 20B can be acquired with high possibility. In other words, a composition in which the direction, in which persons are aggregated, becomes the center of the image, and both ends are in the direction in which persons are rare (the distribution of persons is low) is formed.

Also in a case where a panorama imaging operation is performed in the range of 270° by determining the start position and the end position as described with reference to FIG. 21A, similarly to FIG. 21B, the possibility that a panorama image having a good balance is acquired is high.

As above, a good panorama imaging operation is realized based on the estimation of existence of persons in the surrounding area.

In addition, although the target subject has been described as a face, a specific subject other than a face may be considered as the target subject. It may be configured that map information of a specific target subject is generated, and the start position and the end position of the panorama imaging operation are determined by referring to the generated map information.

In addition, a case where the panorama imaging operation is performed while panning is performed has been assumed and described. However, a case where the panorama imaging operation is performed in the vertical direction while tilting is performed may be also employed. In such a case, a process in which map information is generated in the tilting range, and the start position and the end position of the panorama imaging operation are determined by referring to the map information can be performed.

### [5-4: Process Example IV]

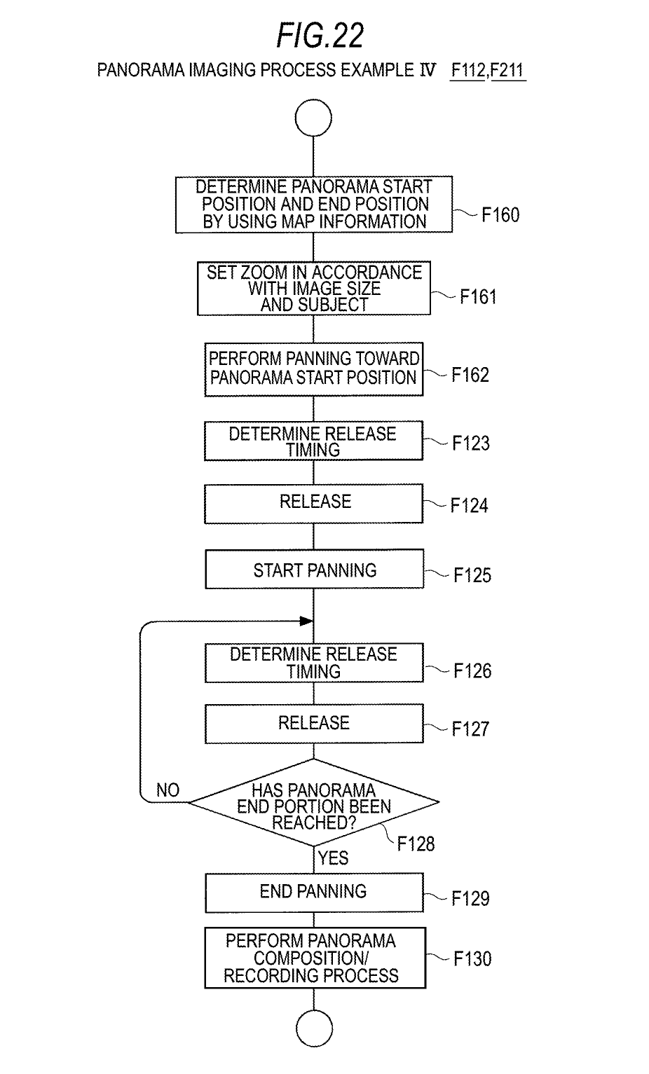

Process Example IV of panorama imaging that can be applied to Step F112 shown in FIG. 11 or Step F211 shown in FIG. 12 will be described with reference to FIGS. 22, 23, 24A, 24B, 25A, 25B, and 25C.

This Process Example IV, similarly to the above-described Process Example III, is also a process in which the start position and the end position of the panorama imaging operation are determined based on imaging history information that represents the existence of a predetermined target subject or the face detection map information that are generated based on the captured image signals acquired in the past.

However, in this Process Example IV, composition adjustment is performed based on the distribution of existence of target subjects at positions in the horizontal direction and at positions in the vertical direction and the size of a panorama image.

More specifically, as the composition adjustment, the zoom magnification rate is calculated, and control of changing the zoom magnification rate of the zoom mechanism is performed.

The process of the control unit 27 will be described with reference to FIG. 22.

First, in Step F160, the start position and the end position of the panorama imaging operation are determined by referring to the face detection map information. This may be regarded to be the same as that of the above-described Process Example III (Step F150 shown in FIG. 18). In other words, the start position and the end position are determined by determining a combined center with reference to the center point of a user who is located on the farthermost side in the face detection map information. In addition, in this example, it is assumed that the size of the image is determined by user's setting, and the angle range of the panorama imaging operation is also determined in accordance with the size of the image.

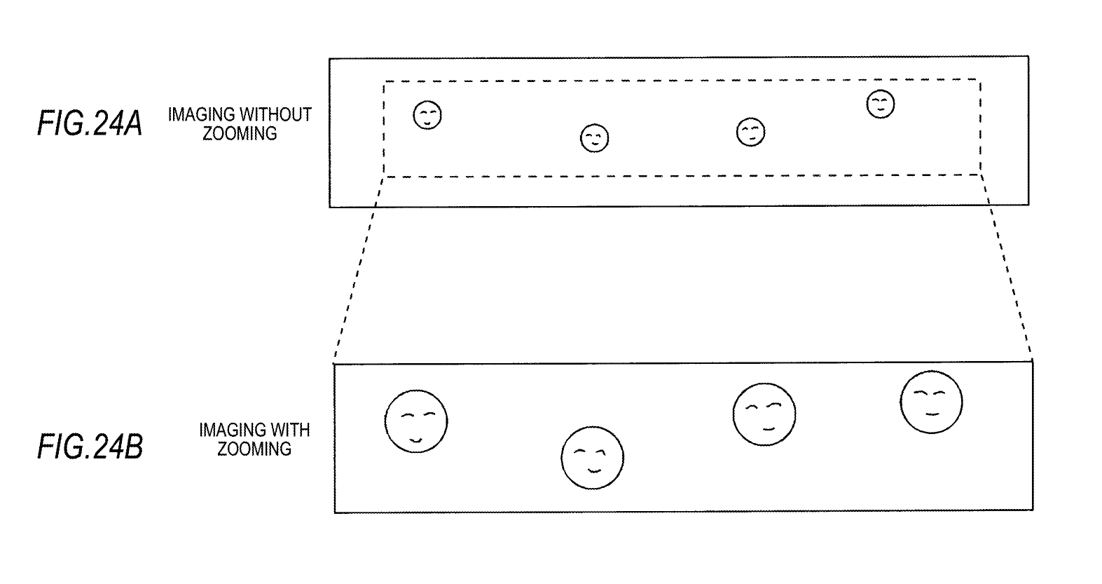

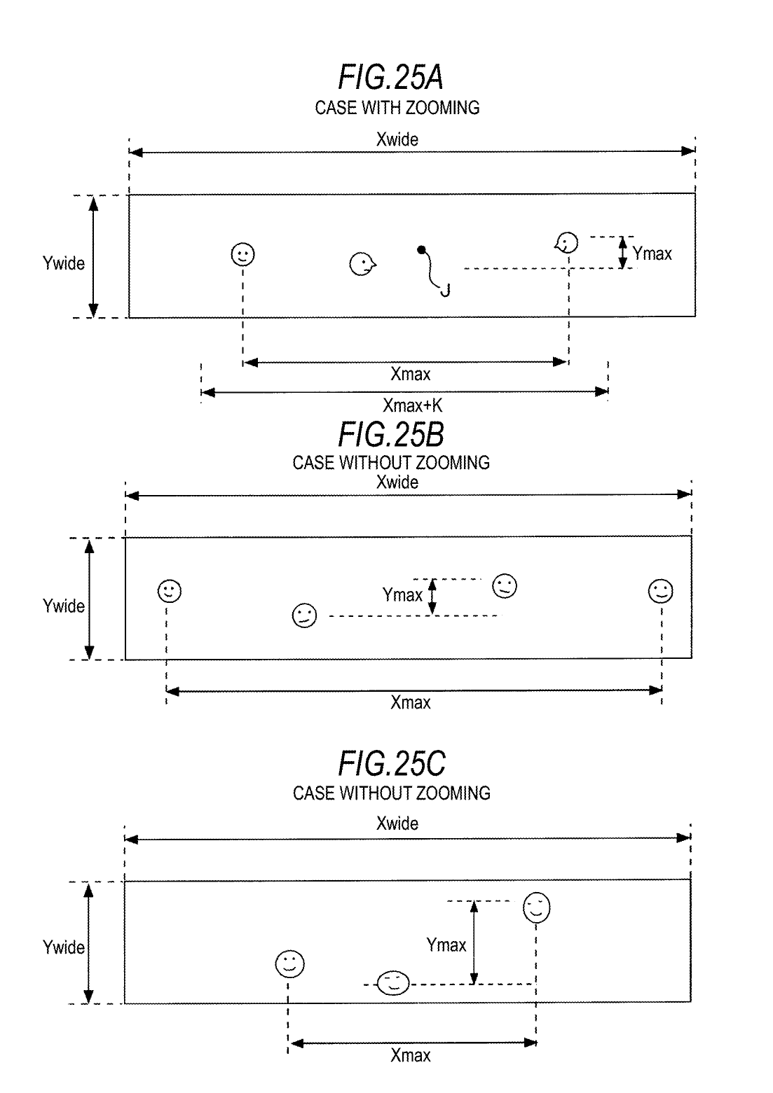

In Step F161, the control unit 27 performs zoom setting in accordance with the size of the image and the status of the subject. This process will be described with reference to FIGS. 24A, 24B, 25A, 25B, and 25C.

It is assumed that a panorama image as shown in FIG. 24A is acquired when a panorama imaging operation is performed without performing any zoom control in a zoom state that is the same as that of an ordinary panorama imaging operation. In this panorama image, faces are transferred in relatively small sizes.

On the other hand, it is assumed that a panorama image as shown in FIG. 24B is acquired when a panorama imaging operation is performed with a changed zoom magnification rate in this situation.

When the panorama images shown in FIGS. 24A and 24B are compared to each other, it can be thought that FIG. 24B is preferable in terms of the composition. The reason for this is that, in FIG. 24B, the composition is enhanced, and each user's face is transferred with high precision so as to improve the image quality.

By performing zoom control at the time of performing a panorama imaging operation, an appropriate panorama image may be acquired. However, performing the zoom control is not typically appropriate. For example, there is a case where a person located on the corner may be excluded by increasing the zoom magnification rate.

Thus, in this example, in Step F161, the control unit 27 determines whether zoom control is to be performed and determines the zoom magnification rate in the case of performing the zoom control, depending on the size of the image and the distribution of the objects.

As determination of zoom setting in Step F161, the control unit 27 performs the process shown in FIG. 23.

First, in Step F191, the control unit 27 calculates maximum separation distances Xmax and Ymax.

The maximum separation distances Xmax and Ymax, as shown in FIGS. 25A to 25C, are separation distances between faces that are located farthest from each other in the horizontal direction and the vertical direction.

The maximum separation distance Xmax in the horizontal direction can be acquired by referring to the face detection map information. In other words, the maximum separation distance Xmax can be acquired based on an angle difference between two faces that are located on the corner-most sides as a distribution of users included in the angle range of the panorama imaging operation.

In addition, in order to acquire the maximum separation distance Ymax in the vertical direction, for example, map information of positions of existing faces may be also generated. For example, when the tilt position and the information of the position within an image frame of each imaging history information unit are used, the absolute position of each detected face image in the vertical direction can be calculated. A map in the vertical direction is generated based on the calculated positions. Then, the positions of two faces that are farthest from each other within the range of the tilt angle of the panorama imaging operation to be performed are determined based on the map, and the separation distance therebetween is acquired.

For example, when acquiring the maximum separation distances Xmax and Ymax as above, the control unit 27 performs calculation of Steps F192 and F193.

First, in Step F192, a value acquired by multiplying a horizontal size Xwide shown in FIGS. 25A to 25C by a predetermined coefficient (here, as an example, 0.8) and the maximum separation distance Xmax are compared together.

In addition, in Step F193, a value acquired by multiplying a vertical size Ywide by a predetermined coefficient (0.8 as an example) and the maximum separation distance Ymax are compared together.

In Steps F192 and F193, when any one of the condition of “Xwide×0.8<Xmax” and the condition of “Ywide×0.8<Ymax” is not satisfied, the zoom control is not performed. In other words, in such a case, ordinary zoom setting for the panorama imaging operation is maintained.

On the other hand, when both of the above-described two conditions are satisfied, the control unit 27 advances the process to Steps F194 and F195, and the zoom control is performed.

In Step F194, the control unit 27 calculates a zoom magnification rate. For example, the zoom magnification rate is set to a magnification rate that is acquired by “Xwide/(Xmax+K). Here, “K” is a value corresponding to a margin after zoom.

Then, in Step F195, the zoom mechanism is controlled to have the zoom magnification rate.

The above-described process will be described with reference to FIGS. 25A to 25C.

For example, the distribution of persons in the surrounding area that is estimated based on the face detection map information is assumed to be as shown in FIG. 25A in the angle range for which the panorama imaging operation is performed. In other words, a panorama image having the same composition as that shown in FIG. 25A is estimated to be acquired.

In this case, any user is not located in the end portions of the image, the faces of the users are relatively aggregated in the center, and the entire composition is not that desirable.

In this case, since the maximum separation distance Xmax is significantly smaller than the horizontal size Xwide, the condition of “Xwide×0.8<Xmax” is satisfied.

In addition, since the maximum separation distance Ymax is significantly smaller than the vertical size Ywide, the condition of “Ywide×0.8<Ymax” is satisfied.

In this case, in Step F194, the zoom magnification rate is calculated, and the zoom control is performed. The zoom magnification rate is set to a magnification rate for which a value acquired by adding the margin K to the maximum separation distance Xmax shown in the figure is the horizontal size Xwide.

Accordingly, the faces of the persons are drawn in an enlarged scale, and therefore, a panorama image having a composition in which the disposition on the image is desirable can be acquired. In other words, the composition as described with reference to FIG. 24B can be acquired.

On the other hand, FIG. 25B shows a case where a composition in which faces of the users are distributed in a relatively wide range in the horizontal direction is formed when an imaging operation is performed in the state of an ordinary zoom magnification rate. In such a case, when the zoom magnification rate is increased, the face of a person located in the corner is excluded.

In this case, the condition of “Xwide×0.8<Xmax” is not satisfied, and thus zoom control is not performed.

In addition, FIG. 25C shows a case where a composition in which the faces of the users are distributed in a relatively wide range in the vertical direction when an imaging operation is performed in the state of an ordinary zoom magnification rate. In this case, when the zoom magnification rate is increased, the face of a person located on the upper side or the lower side may be excluded.

In this case, the condition of “Ywide×0.8<Ymax” is not satisfied, and thus zoom control is not performed.

Here, performing of the zoom control is determined based on whether or not the maximum separation distance Xmax or Ymax is 0.8 times the image size Xwide or Ywide. However, any other factor other than 0.8 times may be applied.

In Step F161 shown in FIG. 22, the control unit 27 performs the zoom setting as above. Then, in Step F161, zoom control is performed or the zoom magnification rate is not changed, and panning control toward the start position of the panorama imaging operation is performed in Step F162. In other words, panning toward the panorama start position determined in Step F160 is performed.

When panning toward the start position of the panorama imaging operation is performed, the panorama imaging operation is performed as the process of Step F123 and thereafter. Steps F123 to F130 are the same as those shown in FIG. 13, and thus, the description thereof is omitted.

In addition, the panorama end position determined in Step F128 is a panorama end position that is determined based on the face detection map information in Step F160.

According to this Process Example IV, similarly to Process Example III, a panorama image having a composition of good balance can be acquired in the automatic panorama imaging operation. Furthermore, the zoom magnification rate is changed when it is determined to be appropriate depending on the distribution status. Accordingly, a panorama image having a more desirable composition and high image quality can be acquired.

In addition, in a case where zoom control is performed in Step F161, a case where a composition in which the tilt control is also optimal may be considered to be acquired. For example, in a case where most of the faces of the users are distributed near the upper end of the imaging viewing field or the like, a case where the faces are aggregated near the upper end of the panorama image by performing zooming may be considered as an extreme case. In such a case, by performing tilt control, a more appropriate composition of a panorama image can be realized.

In addition, also in this process example, the target subject may be a specific subject other than the face.

### [5-5: Process Example V]

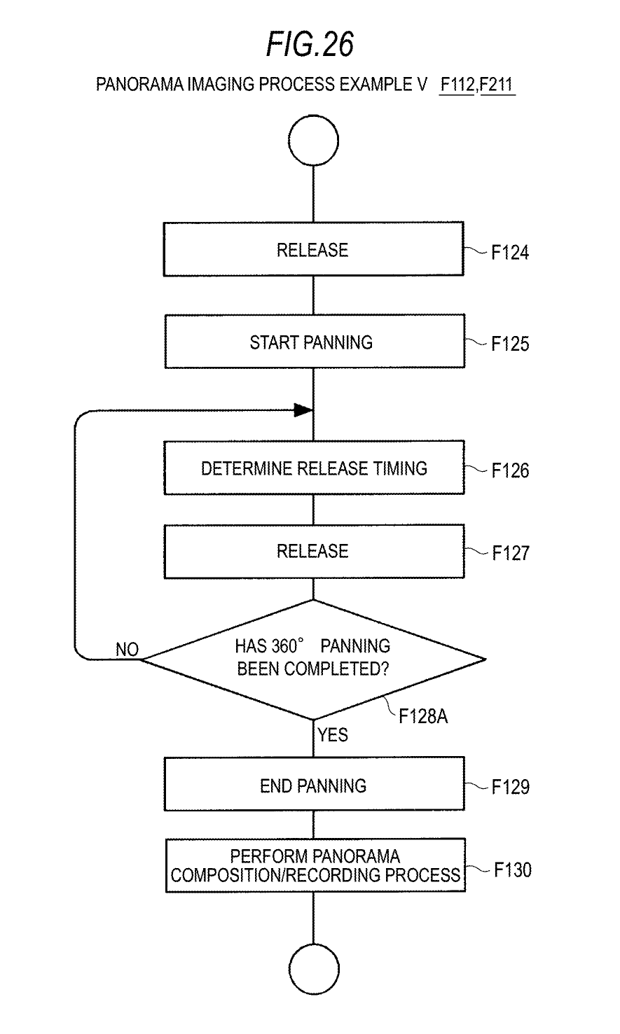

Process Example V of panorama imaging that can be applied to Step F112 shown in FIG. 11 or Step F211 shown in FIG. 12 will be described with reference to FIG. 26.

This Process Example V is an example in which a panorama imaging operation in the range of 360° is instantly performed with the current position in the horizontal direction used as the start position in a case where 360° panorama imaging is performed. In other words, the panorama imaging operation in the range of 360° is performed without performing the composition adjustment in the pan direction.

In a case where the process proceeds to Step F112 shown in FIG. 11 or Step F211 shown in FIG. 12, and a panorama imaging operation is performed, the control unit 27 performs release control with the state at that time point as Step F124 shown in FIG. 26. In other words, first, the first frame image data is acquired without performing composition adjustment.

Then, panning is started in Step F125, release timing is determined in Step F126, and release control is performed in Step F127.

In Step F128A, the control unit 27 monitors completion of 360° panning. The panning angle may be checked based on the pan control amount of the control unit 27, or the control unit 51 of the pan head 10 may be configured to be notified of completion of 360° panning.

When detecting completion of 360° panning, the control unit 27 performs panning completing control in Step F129, and a panorama composition process and a recording process of the panorama image data are performed in Step F130.

This Process Example V is appropriate as a control method in a case where a panorama imaging operation is desired to be performed in a speedy manner.

First, since the panorama imaging operation is performed in the range of 360°, the entirety of the surrounding area can be imaged without performing composition adjustment in the horizontal direction.

Similarly to the above-described Process Examples I to IV, when necessary control of panning, tilt, and zoom is performed before start of the panorama imaging operation, necessary time for the process increases by that much. Thus, timing for panorama imaging may be missed.

Accordingly, when the panorama imaging is desired to be performed immediately, the process as shown in FIG. 26 giving priority to speed even with sacrificing degradation of the composition more or less is appropriately selected.

In FIG. 26, any composition adjustment has been described not to be performed. However, for example, a process example in which only tilt adjustment is performed immediately before Step F124 may be considered.

When only tilt adjustment is performed, a more desirable composition can be realized while considering fast start of the panorama imaging operation.

### <6. Trigger to Panorama Imaging>

### [6-1: Examples of Various Triggers]

Subsequently, triggers for performing panorama imaging will be described. FIGS. 27A, 27B, 28A, 28B, 29A, 29B, 30A, and 30B show process examples of determination of an occurrence of various triggers. These may be regarded, for example, as the process of Step F205 shown in FIG. 12.

FIG. 27A is an example in which a user's touch operation is recognized as a trigger for performing panorama imaging.

When recognizing a touch operation in Step F300, for example, in the middle of the automatic still-image imaging process, the control unit 27 determines an occurrence of a trigger for performing panorama imaging in Step F304. The user's touch operation for the pan head 10 is recognized by the control unit 51 of the pan head 10, and the control unit 27 is notified of the touch operation.

This is a process of determining a trigger that is applied to the case of the above-described Process Example I.

In addition, a case where the control unit 27 recognizes a trigger for panorama imaging in accordance with a user's operation other than a touch operation may be similarly considered.

FIG. 27B is determination of an occurrence of a trigger in a case where panorama imaging is performed in accordance with completion of a search for a predetermined range as automatic still-image imaging or completion of still-image imaging.

The control unit 27 determines whether or not the search for the predetermined range or the still-image imaging is completed in Step F350. When completion thereof is determined, the control unit 27 determines an occurrence of a trigger for performing panorama imaging in Step F351.

As described with reference to FIG. 12, the automatic still-image imaging operation is performed while performing a face search as the process of Steps F206 to F209. For example, areas are set for every 90° of the surrounding area of the pan head 10, and a face is searched for each area using a predetermined search pattern by performing pan and tilt.

By performing such a search and still-image imaging through the areas, an automatic still-image imaging process for the surrounding area of 360° is performed.

For example, at this time point, panorama imaging is performed. In such a case the control unit 27 determines whether a search for the range of 360° is completed as the search for the predetermined range, and in the case of completion thereof, the control unit 27 may recognize an occurrence of a trigger for panorama imaging.

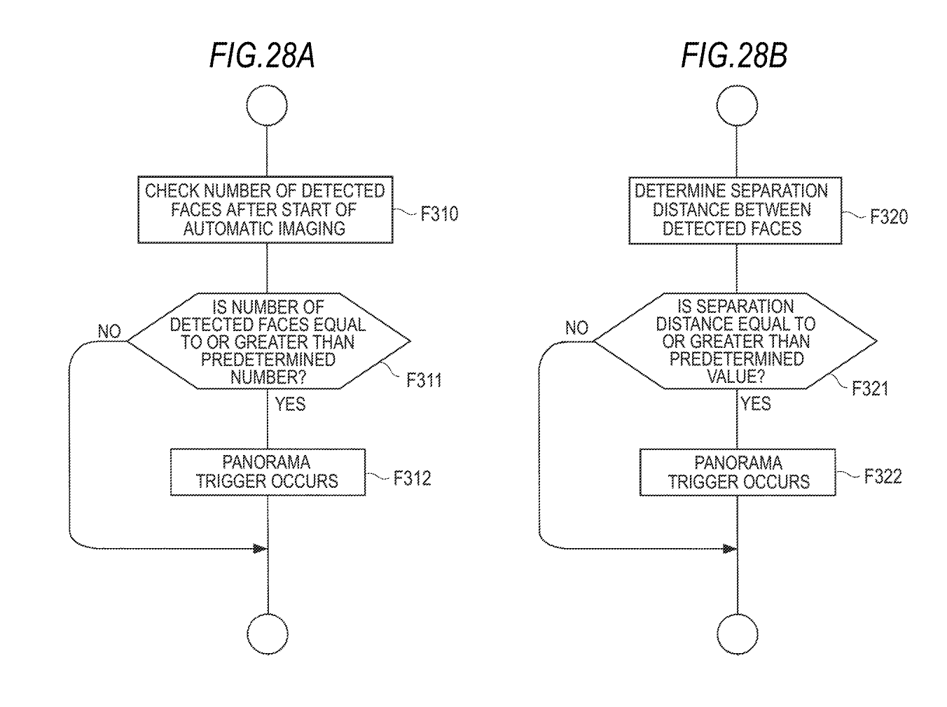

FIG. 28A is an example of a trigger that occurs based on the number of existing predetermined target subjects recognized based on the captured image signal. Here, the target subject is assumed to be a face.

The control unit 27 checks the number of detected faces after start of automatic still-image imaging in Step F310. In other words, the number of persons located in the surrounding area is checked.

For example, by accumulating the above-described imaging history information from the start of automatic still-image imaging, the number of persons located in the surrounding area can be determined. When the personal recognition information included in the imaging history information unit described with reference to FIGS. 19A and 19B is used, the number of persons can be accurately determined to the degree in which individuals can be respectively determined.

Then, when determining that faces corresponding to a predetermined number or more exist in Step F311, the control unit 27 determines an occurrence of a trigger for performing panorama imaging in Step F312.

According to such a trigger, in a case where the still-image is performed, panorama imaging is automatically performed when there are many persons in the surrounding area.

FIG. 28B is an example of a trigger that occurs based on a separation distance between a plurality of specific target subjects.

The control unit 27 determines a separation distance between faces detected in the middle of automatic still-image imaging in Step F320. For example, based on the face detection map information on the basis of the above-described imaging history information, a separation distance between a plurality of persons can be calculated.

Then, when determining the separation distance to be equal to or greater than a predetermined value in Step F321, the control unit 27 determines an occurrence of a trigger for performing panorama imaging in Step F322.

According to such a trigger, when automatic still-image imaging is performed, in a case where there are a plurality of persons in positions departed from each other to some degree, panorama imaging is automatically performed.

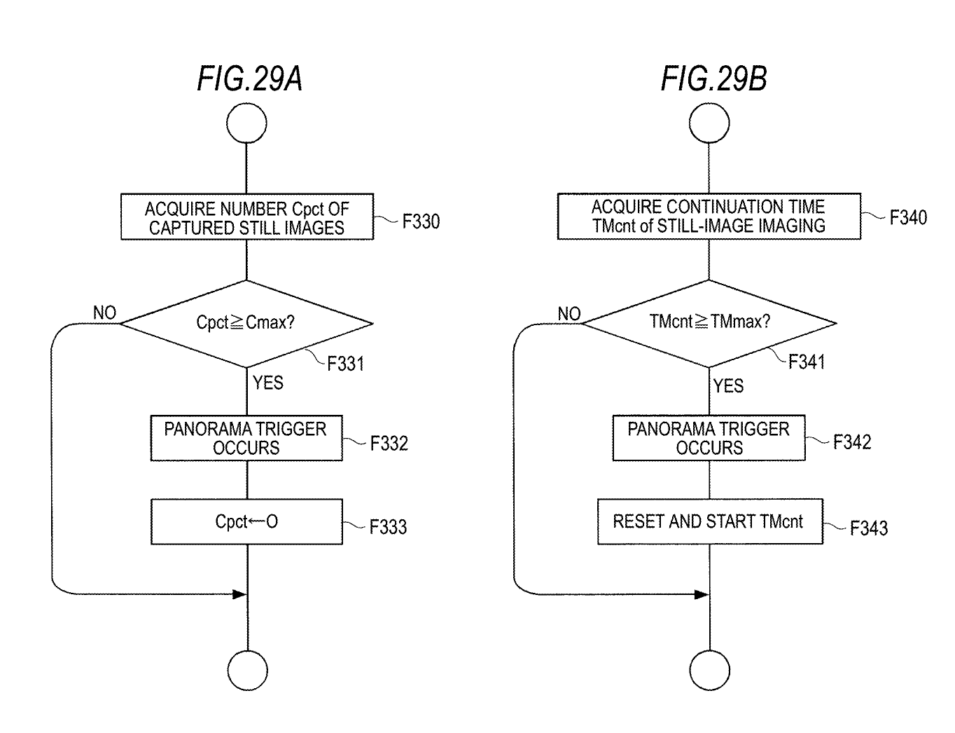

FIG. 29A is a case where panorama imaging is performed by imaging and recording still-images corresponding to a predetermined number in automatic still-image imaging.

The control unit 27 checks the number Cpct of captured images after start of automatic still-image imaging in Step F330. The number Cpct of captured images is a variable number and is incremented each time the process of Step F209 shown in FIG. 12 is performed.

Then, the control unit 27 compares the number Cpct of captured images and a predetermined value Cmax in Step F331.

When Cpct≧Cmax, an occurrence of a trigger for performing panorama imaging is determined in Step F332.

In Step F333, for determining a next trigger, the value of the number Cpct of captured images is reset to “0”.

Based on such determination of a trigger, for example, in a case where the predetermined value Cmax=50, a process can be realized in which panorama imaging is performed each time still-image imaging corresponding to 50 captured images is performed as automatic still-image imaging.

FIG. 29B is a case where panorama imaging is performed on a regular basis in automatic still-image imaging.

The control unit 27 checks the continuation time TMcnt of the automatic still-image imaging operation in Step F340. The continuation time TMcnt is time of a period during which the process of Steps F206 to F209 shown in FIG. 12 is performed. First, counting is started at a time point of Step F203.

Then, the control unit 27 compares the continuation time Tcnt and predetermined time TMmax in Step F341.

When TMcnt≧TMmax, the control unit 27 determines an occurrence of a trigger for performing panorama imaging in Step F342.

In Step F343, in order to determine a next trigger, the value of the continuation time Tcnt is reset to “0”, and then counting is started.

Based on such determination of a trigger, for example, in a case where the predetermined value TMmax=5 minutes, a process can be realized in which panorama imaging is performed every five minutes in the middle of an automatic still-image imaging operation.

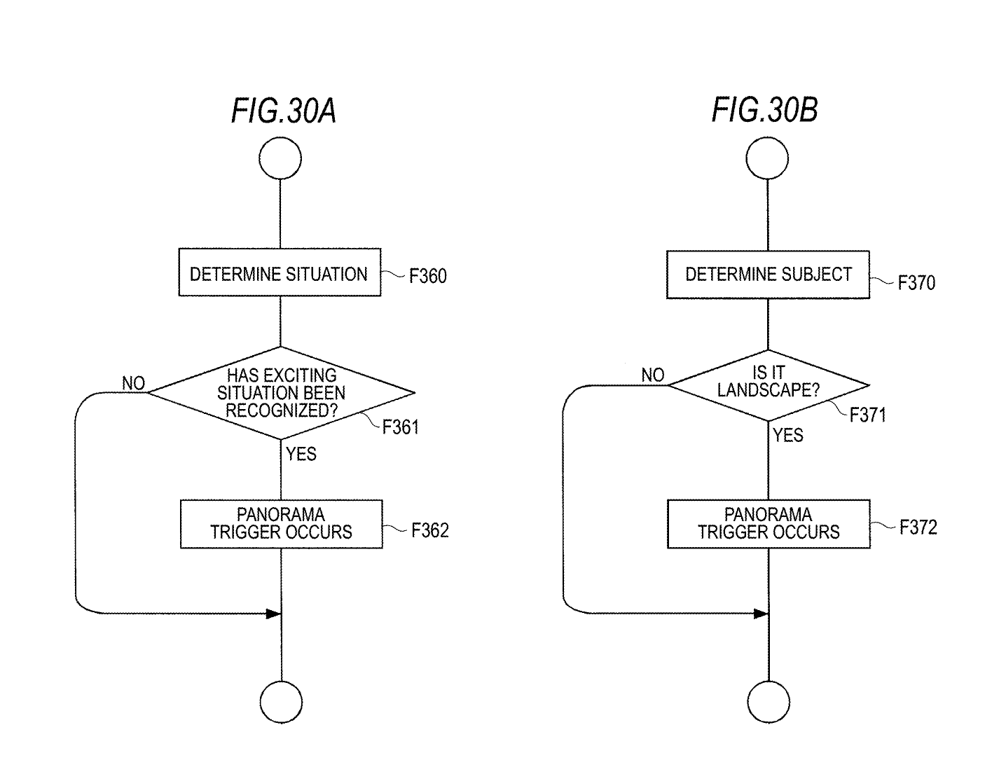

FIG. 30A is an example of a trigger that occurs based on a captured image signal that is analyzed during a subject search in automatic still-image imaging or a subject status that is estimated based on the surrounding sounds. For example, it is determined whether or not there is exciting status.

The control unit 27 performs states determination in Step F360. For example, the surrounding status is estimated, for example, based on a rapid increase in the sound volume that is detected as a sound input, an increase in the movement on the whole through image analysis, or the like.

For example, in a case where there is exciting status at a party or the like, a case where everyone claps his hands, or the like, the input sound volume temporarily increases or movement of a subject increases in a captured image. Accordingly, based on such cases, exciting status can be estimated.

When determining that there is exciting status in Step F361, the control unit 27 determines an occurrence of a trigger for performing panorama imaging in Step F362.

Base on such trigger determination, a process can be realized in which panorama imaging is performed when there is exciting status during automatic still-image imaging.

FIG. 30B is an example of a trigger that occurs based on a specific subject type that is recognized based on a captured image signal during a subject search in automatic still-image imaging.

The control unit 27 performs subject determination in Step F370. For example, the control unit 27 determines whether or not a subject is a natural landscape. For example, a status in which no person or only one or two persons are detected even when a face search is performed in the 360° surrounding area becomes a factor for estimating a subject not to be a party or the like but to be a landscape. In addition, a status in which, relating to the color of a subject, there is a large color area in blue or green that is estimated as the air, the sea, a mountain, or the like, a status in which the luminance of a subject is high and has a value for estimating the subject to be outdoor, or the like becomes an estimation factor for landscape imaging.

Through such condition determination, when determining landscape imaging in Step F371, the control unit 27 determines an occurrence of a trigger for performing panorama imaging in Step F372.

Based on such trigger determination, panorama imaging is automatically performed in the case of landscape imaging.

### [6-2: Process Setting According to Trigger]

Until now, various types of triggers have been described. In a case where a plurality of triggers from among the above-described triggers are employed, it is appropriate that a method used for the panorama imaging process in Step F211 shown in FIG. 12 is changed in accordance with a trigger.

For example, when an occurrence of a trigger is determined in Step F205 shown in FIG. 12, the control unit 27 selects a processing method of Step F211 in accordance with the type of the trigger in Step F210.

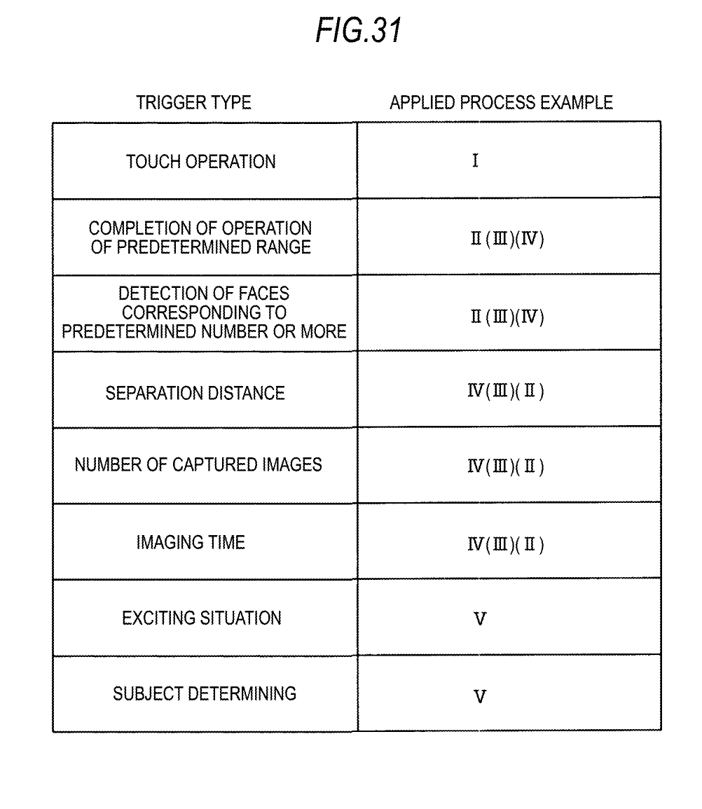

An appropriate example of the panorama imaging process that responds to each type of the trigger is shown in FIG. 31.

When a trigger is recognized through recognition of a touch operation shown in FIG. 27A, as the panorama imaging process of Step F211, it is appropriate to perform Process Example I described with reference to FIG. 13. The reason for this is that a panorama image composition in which a touch operator is located in the center can be realized.

When a trigger, shown in FIG. 27B, according to completion of automatic still-image imaging of a predetermined range is recognized, as the panorama imaging process of Step F211, it is appropriate to perform Process Example II described with reference to FIG. 16. The reason for this is that a panorama image having an appropriate composition according to the position of a surrounding person at that time point can be acquired.

In addition, in this case, as Process Example III shown in FIG. 18 or Process Example IV shown in FIG. 22, a process example using the imaging history information (the face detection map information) can be regarded as appropriate.

When a trigger, shown in FIG. 28A, according to a case where the number of detected faces after start of the automatic still-image imaging is equal to or greater than a predetermined number is recognized, as the panorama imaging process of Step F211, it is appropriate to perform Process Example II described with reference to FIG. 16. The reason for this is as follows. For example, the panorama imaging is performed in a case where faces corresponding to a predetermined number or more are detected. Thus, when non-periodic panorama imaging is considered, it is very appropriate to acquire a panorama image having an appropriate composition according to the position of a surrounding person at the time point of performing the panorama imaging.

In addition, in a case where the imaging history information is accumulated, as Process Example III shown in FIG. 18 or Process Example IV shown in FIG. 22, a process example using the imaging history information (the face detection map information) may be considered to be appropriate also in such a case.

When a trigger, shown in FIG. 28B, according to a case where a separation distance between a plurality of faces is equal to or greater than a predetermined value is recognized, as the panorama imaging process of Step F211, it is appropriate to perform Process Example IV described with reference to FIG. 22. The reason for this is that appropriate zoom control is performed in accordance with the separation distance, whereby a panorama image having a good composition can be acquired.

In addition, in this case, Process Example III shown in FIG. 18 or Process Example II shown in FIG. 16 may be considered to be appropriate.

When a trigger, shown in FIG. 29A, for every still-image imaging of a predetermined number of images or a periodic trigger, shown in FIG. 29B, for every predetermined continuation time of imaging is recognized, as the panorama imaging process of Step F211, it is appropriate to perform Process Example IV described with reference to FIG. 22. The reason for this is as follows. Owing to continuation of the automatic still-image imaging, there are many changes for updating the imaging history information or the face detection map information, and accordingly estimation of existence having high accuracy can be performed. From that point of view, Process Example III shown in FIG. 18 is also appropriate. In addition, Process Example II shown in FIG. 16 may be regarded to be appropriate.

When a trigger, shown in FIG. 30A, according to determination of an exciting status is recognized, as the panorama imaging process of Step F211, it is appropriate to perform Process Example V described with reference to FIG. 26.

The reason for this is that panorama imaging can be performed in a speedy manner without losing the exciting status.

When a trigger, shown in FIG. 30B, according to determination of a landscape is recognized, as the panorama imaging process of Step F211, it is appropriate to perform Process Example V described with reference to FIG. 26. The reason for this is that the landscape at that time point can be appropriately perceived. However, according to setting of a target subject, application of Process Examples II, III, and IV may be very appropriate in the case of the landscape imaging.

The correspondence between the types of the triggers and process examples shown in FIG. 31 is merely an example. However, by changing the panorama imaging processing method in accordance with the trigger as such, appropriate panorama imaging according to various statuses can be performed.

For example, it is assumed that all the eight types of triggers shown in FIG. 31 are employed as the process of Step F205 shown in FIG. 12 in an imaging system configured by the digital still camera 1 and the pan head 10 of this example. In such a case, the control unit 27 selects one of Process Examples I to V in accordance with the trigger type in Step F210, and control of the selected process example is performed in Step F211. Therefore, a panorama image having a composition that is appropriate to the status can be acquired.

### <7. Other Functional Configuration Examples>

As above, although the operations of the embodiment have been described, until now, the operations have been described as a control process that is based on the functional configuration shown in FIG. 9.

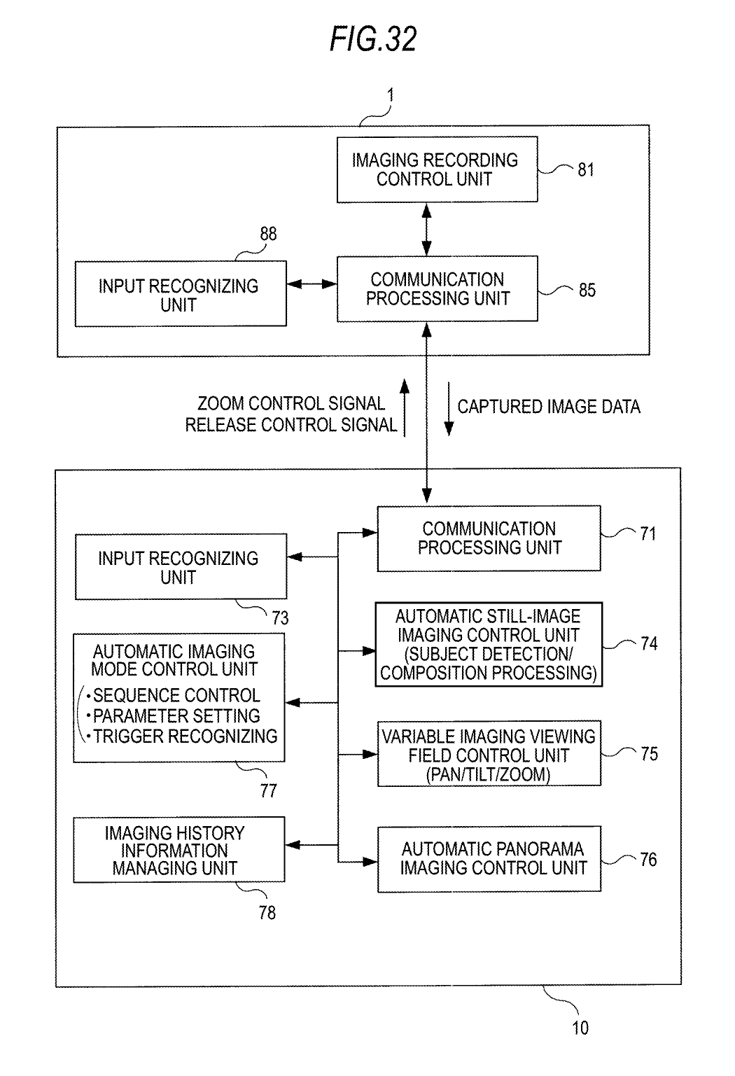

For example, in an imaging system that is configured by the digital still camera 1 and the pan head 10, functional configuration examples other than that shown in FIG. 9 may be considered. An example is shown in FIG. 32.

FIG. 32 is an example in which the digital still camera 1 side only includes an imaging and recording control unit 81, a communication processing unit 85, and an input recognizing unit 88. On the pan head 10 side (the control unit 51), a communication processing unit 71, an input recognizing unit 73, an automatic still-image imaging control unit 74, a variable imaging viewing field control unit 75, an automatic panorama imaging control unit 76, an automatic imaging mode control unit 77, and an imaging history information managing unit 78 are provided.

The control process performed by each functional unit is basically the same as that described with reference to FIG. 9. However, the following is different.

The automatic panorama imaging control unit 76 and the automatic still-image imaging control unit 74 are supplied with captured image data as each frame image from the signal processing unit 24 of the digital still camera 1. Then, necessary image analysis is performed.

However, as described with reference to FIG. 8, in a case where the imaging unit 63 is disposed on the pan head 10 side, image analysis or a composition process can be performed based on the captured image data of the imaging unit 63.

In addition, the panorama imaging control unit 76 directs the control unit 27 (the imaging and recording control unit 81) located on the digital still camera 1 side to acquire frame image data during a panning process as a panorama imaging operation or a panorama composition process through the communication processing unit 71.

The variable imaging viewing field control unit 75 performs a pan/tilt operation for subject detection or composition combining by controlling the pan driving unit 55 and the tilt driving unit 58 in response to a direction from the automatic still-image imaging control unit 74 or the automatic panorama imaging control unit 76.

In addition, for zoom control, the variable imaging viewing field control unit 75 outputs a zoom control signal to the control unit 27 (the imaging and recording control unit 81) located on the digital still camera 1 side through the communication processing unit 71. The imaging and recording control unit 81 controls a zoom process for composition combining based on the zoom control signal.

In addition, the automatic imaging mode control unit 77, in order to realize the process operation, for example, as shown in FIGS. 11 and 12, transmits directions to each functional portion.

The automatic imaging mode control unit 77, in order to perform the release process of Step F109 shown in FIG. 11 or Step F209 shown in FIG. 12, outputs a release control signal to the control unit 27 (the imaging and recording control unit 81) located on the digital still camera 1 side through the communication processing unit 71. The imaging and recording control unit 81 controls a still-image recording operation in accordance with the release control signal.

In addition, the automatic imaging mode control unit 77 performs detection of a user operation, detection of an external sound, image determination, and the like as recognition of a trigger. In a case where the audio input unit 62 is installed in the pan head 10, the input recognizing unit 73 recognizes a sound input, and the automatic imaging mode control unit 77 performs trigger determination.

In other words, FIG. 32 shows an example in which the pan head 10 side realizes the automatic still-image imaging and the automatic panorama imaging by independently controlling the automatic imaging mode so as to provide a necessary direction to the control unit 27 of the digital still camera 1.

In this case, the above-described Process Examples I to V and the trigger recognizing process may be regarded as the processes of the control unit 51 of the pan head 10. As above, the functional configuration examples shown in FIGS. 9 and 32 have been described. When the functional configuration shown in FIG. 9 is employed, the imaging control device according to an embodiment of the present invention is mounted in the digital still camera 1. On the other hand, when the functional configuration shown in FIG. 32 is employed, the imaging control device according to an embodiment of the present invention is mounted in the pan head 10.

The imaging control device according to an embodiment of the present invention includes at least the automatic panorama imaging control unit (84 or 76) and the variable imaging viewing field control unit (83 or 75).

Accordingly, even when the functional portions are divided and installed to separate devices, a device including at least the automatic panorama imaging control unit (84 or 76) and the variable imaging viewing field control unit (83 or 75) is an example of implementation of an embodiment of the present invention.

Alternatively, in a case where the automatic panorama imaging control unit (84 or 76) and the variable imaging viewing field control unit (83 or 75) are configured as the functions of separate devices, an embodiment of the present invention is implemented by a system configured by the devices.

In the above-described embodiment, an example in which the panorama imaging is performed as automatic imaging has been described. However, the above-described process examples I to V can be applied as a process in a case where the panorama imaging is directed not in the middle of an automatic imaging process by a user operation.

### <8. Program>

A program for implementing the imaging control device according to an embodiment of the present invention can be provided.

The program according to an embodiment of the present invention is a program that allows an operation processing device (the control unit 27 or the like) such as a CPU to perform the above-described processes shown in FIGS. 11 and 12, the processes of Process Examples I to V, and the process of trigger recognition.

The program according to the embodiment allows acquisition of a plurality of image data used for generating panorama image data as panorama imaging while changing the imaging viewing field by controlling the driving of the variable pan/tilt mechanism. Then, before or during the panorama imaging operation, the program allows the operation processing device to perform a process of determining a control operation at the time of performing panorama imaging based on a captured image signal.

In addition, the program according to the embodiment determines a control operation at the time of performing panorama imaging in accordance with a trigger for performing panorama imaging. Then, the program allows the operation processing device to acquire a plurality of image data used for generating panorama image data through imaging as panorama imaging based on the determined control operation while changing the imaging viewing field by controlling the driving of the variable pan/tilt mechanism.

The program according to this embodiment may be recorded in advance in an HDD as a recording medium that is built in a device such as a personal computer, the digital still camera 1, or the pan head 10, a ROM inside a microcomputer having a CPU, or the like.

Alternatively, the program may be temporarily or permanently stored (recorded) in a removable recording medium such as a flexible disc, a CD-ROM (Compact Disc Read Only Memory), an MO (Magnet Optical) disk, a DVD (Digital Versatile Disc), a Blu-ray disc, a magnetic disk, a semiconductor memory, or a memory card. In addition, such a removable recording medium can be provided as so-called package software.

In addition, the program according to an embodiment of the present invention may be installed to a personal computer or the like from a removable recording medium or downloaded from a download site through a network such as a LAN (Local Area Network) or the Internet.

A program according to an embodiment of the present invention is appropriate for implementation of an imaging device and an imaging system that perform the process of the above-described embodiment and for broad applications.

The present application contains subject matter related to that disclosed in Japanese Priority Patent Application JP 2010-050086 filed in the Japan Patent Office on Mar. 8, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging control device for an imaging apparatus or an imaging system that includes an imaging unit imaging a subject and a variable mechanism of an imaging viewing field of the imaging unit, the imaging control device comprising:
a variable imaging viewing field control unit that controls driving of the variable mechanism of the imaging viewing field; and
an automatic panorama imaging control unit that, while changing the imaging viewing field by using the variable imaging viewing field control unit, allows the imaging unit to acquire a plurality of image data used for generating panorama image data through imaging as panorama imaging and determines a control operation at the time of the panorama imaging based on an captured image signal acquired by the imaging unit.

2. The imaging control device according to claim 1,
wherein the automatic panorama imaging control unit determines a start position and an end position of the panorama imaging based on determination of existence of a predetermined target subject that is recognized based on the captured image signal acquired by the imaging unit.

3. The imaging control device according to claim 2,
wherein the automatic panorama imaging control unit sets as a start position of the panorama imaging a position of the imaging viewing field at a time when the target subject is determined not to exist for a predetermined range or for predetermined time based on the captured image signal that is acquired by the imaging unit when allowing the variable imaging viewing field control unit to move the imaging viewing field using the variable mechanism, and
wherein the automatic panorama imaging control unit sets as an end position of the panorama imaging a position of the imaging viewing field at a time when the target subject is determined not to exist for the predetermined range or the predetermined time based on the captured image signal that is acquired by the imaging unit in the middle of performing the panorama imaging.

4. The imaging control device according to claim 1,
wherein the automatic panorama imaging control unit determines a start position and an end position of the panorama imaging based on history information that represents existence of a predetermined target subject and is generated based on the captured image signal acquired by the imaging unit in the past.

5. The imaging control device according to claim 4,
wherein the automatic panorama imaging control unit determines a distribution of existence of the target subject that is acquired based on the history information and determines the start position and the end position of the panorama imaging based on the distribution of existence.

6. The imaging control device according to claim 4,
wherein the automatic panorama imaging control unit performs composition adjustment based on a distribution of existence of the target subject at positions in the horizontal direction and positions in the vertical direction and a size of a panorama image of the target subject that are acquired based on the history information.

7. The imaging control device according to claim 6,
wherein the automatic panorama imaging control unit, as the composition adjustment, calculates a zoom magnification rate and allows the variable imaging viewing field control unit to change the zoom magnification rate of a zoom mechanism that is one of the variable mechanisms.

8. The imaging control device according to claim 1,
wherein the automatic panorama imaging control unit, as composition adjustment before start of the panorama imaging, allows the variable imaging viewing field control unit to only perform control of adjustment of a position of the imaging viewing field in the vertical direction.

9. An imaging control device for an imaging apparatus or an imaging system that includes an imaging unit imaging a subject and a variable mechanism of an imaging viewing field of the imaging unit, the imaging control device comprising:
a variable imaging viewing field control unit that controls driving of the variable mechanism of the imaging viewing field; and
an automatic panorama imaging control unit that, while changing the imaging viewing field by using the variable imaging viewing field control unit, allows the imaging unit to acquire a plurality of image data used for generating panorama image data through imaging as panorama imaging and determines a control operation at the time of the panorama imaging in accordance with a trigger for performing the panorama imaging.

10. The imaging control device according to claim 9,
wherein the automatic panorama imaging control unit determines a start position and an end position of the panorama imaging such that a horizontal position of a user operation becomes a center of a panorama image, in a case where the panorama imaging is performed in accordance with the trigger on the basis of the user operation.

11. The imaging control device according to claim 9,
wherein the automatic panorama imaging control unit performs the panorama imaging while changing the imaging viewing field in a 360° range in the horizontal direction by using the variable imaging viewing field control unit, with a current position in the horizontal direction being used as a start position, in a case where the panorama imaging is performed in accordance with the trigger for 360° panorama imaging.

12. The imaging control device according to claim 9,
wherein the panorama imaging control unit performs panorama imaging control in accordance with the trigger that occurs based on the number of existing predetermined target subjects or a separation distance between a plurality of the predetermined target subjects that is recognized based on the captured image signal acquired by the imaging unit.

13. The imaging control device according to claim 9, further comprising: an automatic still-image imaging control unit that allows the imaging apparatus to automatically perform still-image imaging by performing subject detection while changing the imaging viewing field by using the variable imaging viewing field control unit,
wherein the panorama imaging control unit performs the panorama imaging control in accordance with the trigger that occurs based on the number of times of the still-image imaging, a period of the automatic still-image imaging, or completion of the automatic still-image imaging in a predetermined range, according to control of the automatic still-image imaging control unit.

14. The imaging control device according to claim 12,
wherein the automatic panorama imaging control unit determines a start position and an end position of the panorama imaging based on determination of existence of a predetermined target subject that is recognized based on the captured image signal acquired by the imaging unit.

15. The imaging control device according to claim 12,
wherein the automatic panorama imaging control unit determines a start position and an end position of the panorama imaging based on history information that represents existence of a predetermined target subject and is generated based on the captured image signal acquired by the imaging unit in the past.

16. The imaging control device according to claim 9,
wherein the panorama imaging control unit performs panorama imaging control in accordance with the trigger that occurs based on a subject status that is estimated based on the captured image signal acquired by the imaging unit and/or a surrounding sound.

17. The imaging control device according to claim 9,
wherein the panorama imaging control unit performs panorama imaging control in accordance with a trigger that occurs based on a predetermined type of the subject that is recognized based on the captured image signal acquired by the imaging unit.

18. The imaging control device according to claim 16, wherein the automatic panorama imaging control unit, as composition adjustment before start of the panorama imaging, allows the variable imaging viewing field control unit to only perform control of adjustment of a position of the imaging viewing field in the vertical direction.

19. A method of controlling imaging for an imaging apparatus or an imaging system that includes an imaging unit imaging a subject and a variable mechanism of an imaging viewing field of the imaging unit, the method comprising the step of:
allowing the imaging unit to acquire a plurality of image data used for generating panorama image data through imaging as panorama imaging while changing the imaging viewing field by controlling driving of the variable mechanism and determining a control operation at the time of the panorama imaging based on an captured image signal acquired by the imaging unit before or during the performing of the panorama imaging.

20. A method of controlling imaging for an imaging apparatus or an imaging system that includes an imaging unit imaging a subject and a variable mechanism of an imaging viewing field of the imaging unit, the method comprising the step of:
determining a control operation at the time of panorama imaging in accordance with a trigger for performing the panorama imaging; and allowing the imaging unit to acquire a plurality of image data used for generating panorama image data through imaging as panorama imaging by the determined control operation while changing the imaging viewing field by controlling driving of the variable mechanism.
